(19) United States
(12) Patent Application Publication
(10) Pub. No.: US 2006/0067667 A1
(43) Pub. Date: Mar. 30, 2006

(54) Image pick-up equipment with bracket photographing function

(75) Inventor: Kazunori Kita, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 11/236,455

(22) Filed: Sep. 27, 2005

(30) Foreign Application Priority Data
Sep. 29, 2004 (JP) 2004-283938

(51) Int. Cl. G03B 15/02

(52) U.S. Cl. 396/180

(57) ABSTRACT

Equipment of the invention is for effectively obtaining images under desired photographing condition and also for shortening a time of photographing operation in continuous shooting. The equipment is provided with a light-emitting control unit for generating an electric signal for controlling a flash light-emitting operation for each photographing operation in plural operations of bracket photographing, a light-emitting unit including plural flash light tubes disposed at different positions respectively, and main capacitors provided for the flash light tubes respectively, and a light-emitting member driving unit for making the plural flash light-emitting tubes separately to emit light or cease emitting light. The light-emitting member driving unit controls the light-emitting position or light-emitting angle of the light-emitting unit based on the electric signal from the light-emitting control unit, and charges a main capacitor for a flash light-emitting member while other flash light-emitting tube is emitting light.

### BACKGROUND OF THE INVENTION

### FIELD OF THE INVENTION

In general, when an object or person is photographed with strobe light, an image photographed under front lighting shows a rather flat image. Therefore, an oblique lighting, side lighting, or combination thereof are used to stress clear-cut feature, shadows and look solid of a face of the person to be photographed, thereby describing minute face expression.

To realize the oblique lighting or side lighting, an illuminating device and detachable flash light-emitting device, and the like are used. In the illuminating device and flash light-emitting device, a light-emitting member of a large guide number (herein after, “GN”) is used, which GN represents light intensity (light-emitting amount) of the flashlight. These illuminating device and flash light-emitting device are provided with a mechanism for using light reflected on a ceiling to indirectly illuminating the object, and a function of changing a range of light-emitting angle to increase a light reaching distance. Meanwhile, a conventional camera is known, which has so called bracketing function, that is, continuous shooting function of photographing plural frames successively with a single release operation by a user, while an exposure level is changed step by step for each frame. The bracketing function is classified into two functions, one is an exposure bracketing function (hereinafter, “AEB”, or “Automatic Exposure Bracket”) for changing an exposure value which is simply determined by an aperture value and a shutter speed, and the other is a strobe bracketing function for changing light-emitting amount of a flash light-emitting device. The camera with these functions is used to photograph the same object plural times, obtaining plural frames of images, and the user can select pictures of the object photographed under his or her desired photographing condition from among these frames.

When the strobe continuous shooting is performed using the flash light-emitting device, once strobe shooting has been performed, the user has to wait before starting another shooting until a capacitor for emitting light is charged completely in the flash light-emitting device. A long charging time of the capacitor increases a shooting interval, and as a result, the user often loses a shooting chance.

It is known that the light-emitting member can emit light when the capacitor is charged to a voltage at which the member can emit light even if the capacitor has not yet been charged completely. A camera using this feature of the capacitor has been developed, which has a function of prioritizing exposure operation by temporarily interrupting charging operation of the capacitor.

In this kind of camera, since its flashmatic means automatically sets the guide number determined at the time when the capacitor is charged completely, an error in guide number can cause an error in aperture value which is determined based on the guide number and the distance to the object, resulting in under exposure.

Meanwhile, a strobe device has been developed, which serves as the flash light-emitting device that can reduce the photographing interval and realize an appropriate exposure during the strobe continuous shooting. In such strobe device, the capacitor charging operation ceases at the time when a charging voltage is reached to a value at which the strobe light can emit light, whereby the capacitor charging time is decreased, and the flashmatic means corrects control of the aperture, reducing the continuous-shooting interval.

Further, a camera provided with two sets of light-emitting devices has been developed. The light-emitting devices are switched while at least two frames are continuously photographed, and the light-emitting amounts of left-side and right-side strobe light are controlled by detecting imbalance between left side and right side of the object.

But this kind of camera has a drawback that a large amount of electric power is consumed by making the strobe light emit light continuously during the continuous shooting. The drawback has not yet been solved.

In the above mentioned strobe light device and the strobe light device installed in the camera, when the capacitor is not charged completely but to a voltage at which light-emitting member can emit light, a capacitor charging time of, for example, more than several seconds is required and the capacitor charging operation is repeatedly performed every photographing operation. Therefore, when the object is a person, the person is forced to keep the same posture and expression for a while. When the object moves or changes slightly, different images of the object are photographed under different conditions, and the satisfactory result is not obtained often.

In a strobe light device a built-in a compact camera, a space for receiving Xenon tubes and capacitors is restricted. Therefore, GN and light-emitting amount are decreased, resulting in decreasing the light reaching distance and giving no choice other than the front light, whereby photographed images show rather flat and less look solid image.

Among these compact cameras with a strobe light device having the strobe bracketing function for changing setting of the light angle and lighting position such as the function for oblique lighting or side lighting, there is no camera which is arranged to decrease the photographing time in the strobe bracketing photographing operation to reduce large electric power consumption.

The present invention has been made in order to solve the above mentioned drawbacks or problems, and has an object to provide image pick-up equipment for effectively obtaining images under the desired photographing condition and for reducing a photographing time in continuous shooting, a controlling method and a controlling program.

### SUMMARY OF THE INVENTION

According to the first aspect of the invention, there is provided image pick-up equipment which comprises an image pick-up unit for performing a photographing operation in response to a release operation by a user, a photographing control unit for making the image pick-up unit execute a bracket photographing operation to perform photographing operations plural times in success in response to a single release operation by the user, a light-emitting unit having plural light-emitting members disposed respectively at different positions, a light-emitting control unit for generating an electric signal for controlling light-emitting operation of the light-emitting unit for each photographing operation in the bracket photographing operation of the image pick-up unit, charge storage units provided respectively for the light-emitting members of the light-emitting unit, and a light-emitting member driving unit for driving the plural light-emitting members of the light-emitting unit separately so as to emit light or cease emitting light, and for charging the charge storage unit of the light-emitting member while other light-emitting member is emitting light.

According to the second aspect of the invention, there is provided image pick-up equipment which comprises an image pick-up unit for performing a photographing operation in response to a release operation by a user, a photographing control unit for making the image pick-up unit execute a bracket photographing operation to perform photographing operations plural times in success in response to a single release operation by the user, a light-emitting unit having plural light-emitting members disposed respectively at different positions, the light-emitting member including a light-emitting diode, a light-emitting control unit for generating an electric signal for controlling light-emitting operation of the light-emitting unit for each photographing operation in the bracket photographing operation of the image pick-up unit, and a light-emitting member driving unit for driving the plural light-emitting diodes of the light-emitting unit separately so as to emit light or cease emitting light.

According to the third aspect of the invention, there is provided a method of controlling image pick-up equipment which has a light-emitting unit including plural light-emitting members, each light-emitting member provided with a charge storage unit, which method comprises the steps of executing a bracket photographing operation to perform photographing operations plural times in success in response to a single release operation, determining a light-emitting condition including at least one of a light-emitting position and light-emitting angle, generating an electric signal for controlling a light-emitting operation for each photographing operation based on the determined light-emitting condition, making the light-emitting unit emit light based on the generated electric signal, and charging the charge storage unit of the light-emitting member while other light-emitting member is emitting light.

According to fourth aspect of the invention, there is provided a method of controlling image pick-up equipment which is provided with a light-emitting unit including plural light-emitting diodes, which method comprises the steps of executing a bracket photographing operation to perform photographing operations plural times in success in response to a single release operation by a user, determining a light-emitting condition including at least one of a light-emitting position and light-emitting angle, generating an electric signal for controlling a light-emitting operation for each photographing operation based on the determined light-emitting condition, and making the light-emitting unit emit light based on the generated electric signal.

According to the fifth aspect of the invention, there is provided a storage medium storing a control program, the control program for controlling a light-emitting unit which has plural light-emitting members each provided with a charge storage unit, which control program comprises a code for executing a bracket photographing operation to perform photographing operations plural times in success in response to a single release operation by a user, a code for determining a light-emitting condition including at least one of a light-emitting position and light-emitting angle, a code for generating an electric signal for controlling a light-emitting operation for each photographing operation based on the determined light-emitting condition, a code for making the light-emitting unit emit light based on the generated electric signal, and a code for charging the charge storage unit of the light-emitting member while other light-emitting member is emitting light.

According to sixth aspect of the invention, there is provided a storage medium storing a control program, the control program for controlling a light-emitting unit having plural light-emitting diodes, which control program comprises a code for executing a bracket photographing operation to perform photographing operations plural times in success in response to a single release operation by a user, a code for determining a light-emitting condition including at least one of a light-emitting position and light-emitting angle, a code for generating an electric signal for controlling a light-emitting operation for each photographing operation based on the determined light-emitting condition, and a code for making the light-emitting unit emit light based on the generated electric signal.

According to seventh aspect of the invention, there is provided image pick-up equipment having a flash light-emitting device for a bracket photographing operation for performing photographing operations plural times in success in response to a single release operation by a user, which equipment comprises light-emitting control means for generating an electric signal for controlling light-emitting operation of the flash light-emitting device for each photographing operation in the bracket photographing operation, light-emitting means having plural light-emitting members disposed at different positions or having different light-emitting angles, respectively, electric charge storage means provided for each of the light-emitting members of the light-emitting means, and light-emitting member driving means for making the light-emitting member of the light-emitting means emit light or cease emitting light separately from other based on the generated electric signal, and for charging the electric charge storage means of the light-emitting member while other light-emitting member is emitting light.

According to the eighth aspect of the invention, there is provided image pick-up equipment having a flash-light emitting device for a bracket photographing operation for performing photographing operations plural times in success in response to a single release operation by a user, which equipment comprises a memory for storing photographed image data, light-emitting control means for generating an electric signal for controlling light-emitting operation of the flash light-emitting device for each photographing operation in the bracket photographing operation, light-emitting means having plural light-emitting members disposed at different positions or having different light-emitting angles, respectively, light-emitting member driving means for making the plural light-emitting members of the light-emitting means emit light or cease emitting light separately from other based on the electric signal generated by the light-emitting control means, and image pick-up means for photographing an object plural times in response to a single release operation under illumination of the light-emitting members disposed at different positions to obtain plural image data, and for storing the obtained image data in the memory. According to the ninth aspect of the invention, there is provided image pick-up equipment having a flash light-emitting device for a bracket photographing operation for performing photographing operations plural times in success in response to a single release operation by a user, which equipment comprises light-emitting control means for generating an electric signal for controlling light-emitting operation of the flash light-emitting device for each photographing operation in the bracket photographing operation, light-emitting means having plural light-emitting diodes disposed at different positions or having different light-emitting angles respectively, and light-emitting member driving means for making the light-emitting diode of the light-emitting means emit light or cease emitting light separately from other based on the electric signal generated by the light-emitting control means.

### BRIEF DESCRIPTION OF THE DRAWIONGS

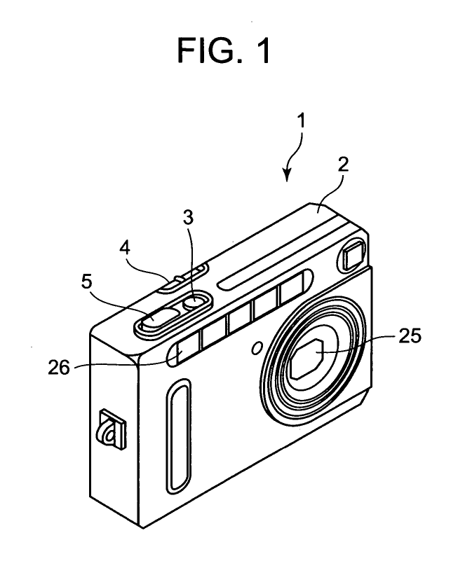

FIG. 1 is a perspective view of digital camera equipment according to the present invention.

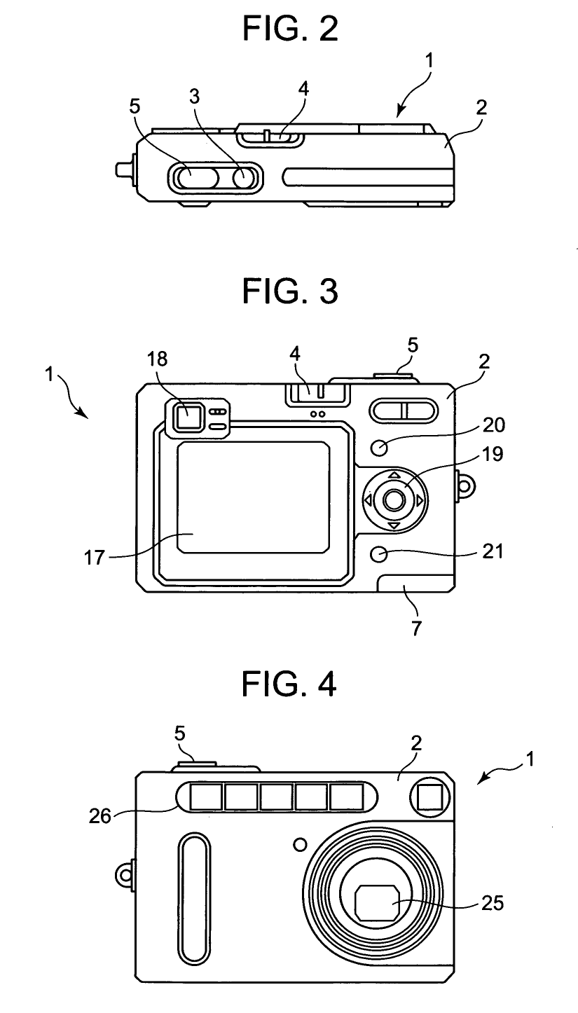

FIG. 2 is a plane view of the digital camera equipment.

FIG. 3 is a rear view of the digital camera equipment.

FIG. 4 is a front view of the digital camera equipment.

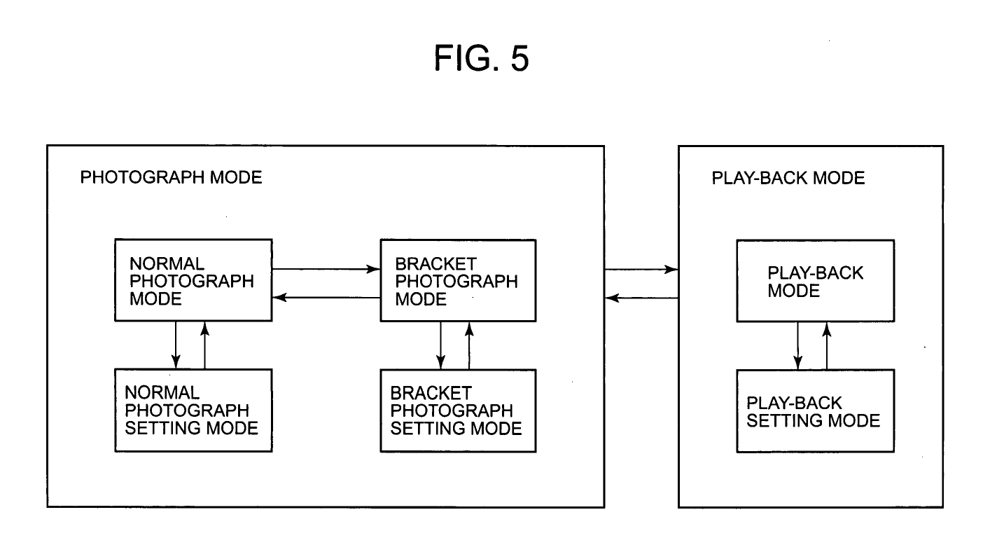

FIG. 5 is a schematic view showing various modes in the digital camera equipment.

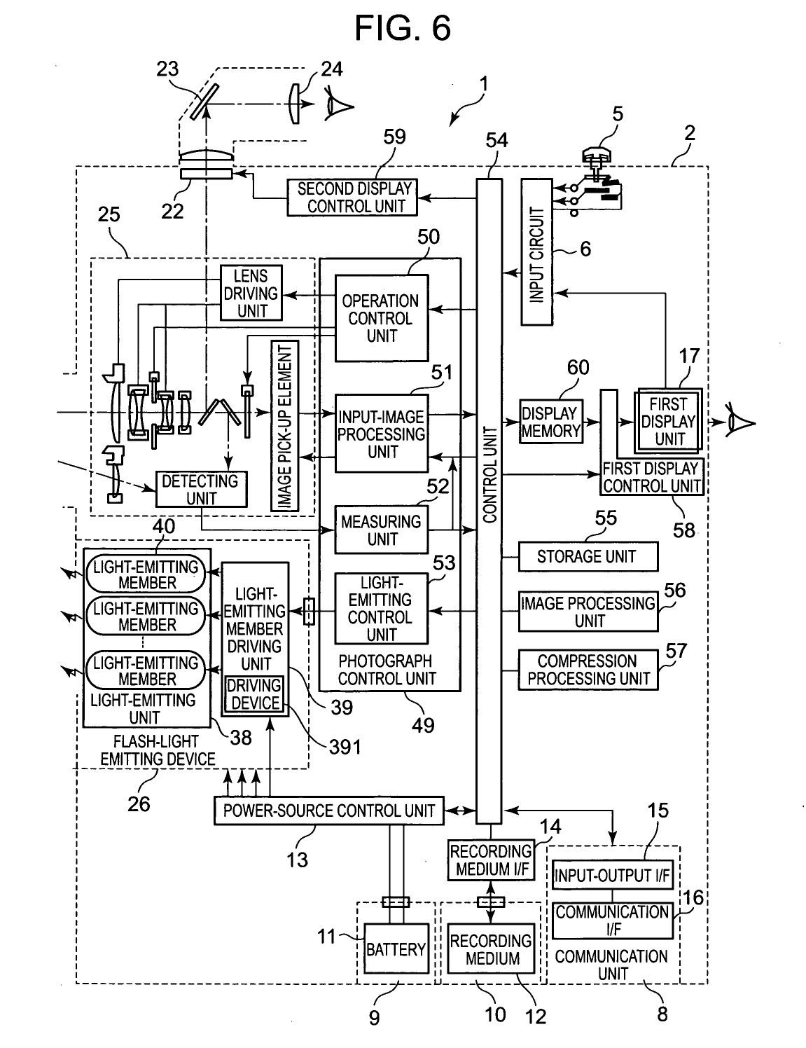

FIG. 6 is a block diagram of a circuit configuration of the digital camera equipment.

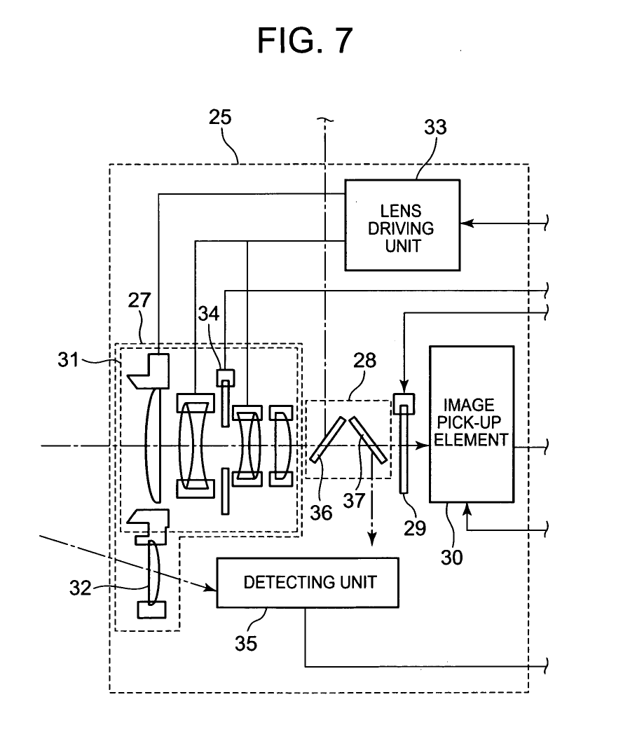

FIG. 7 is a schematic view showing a configuration of an image pick-up unit in the digital camera equipment.

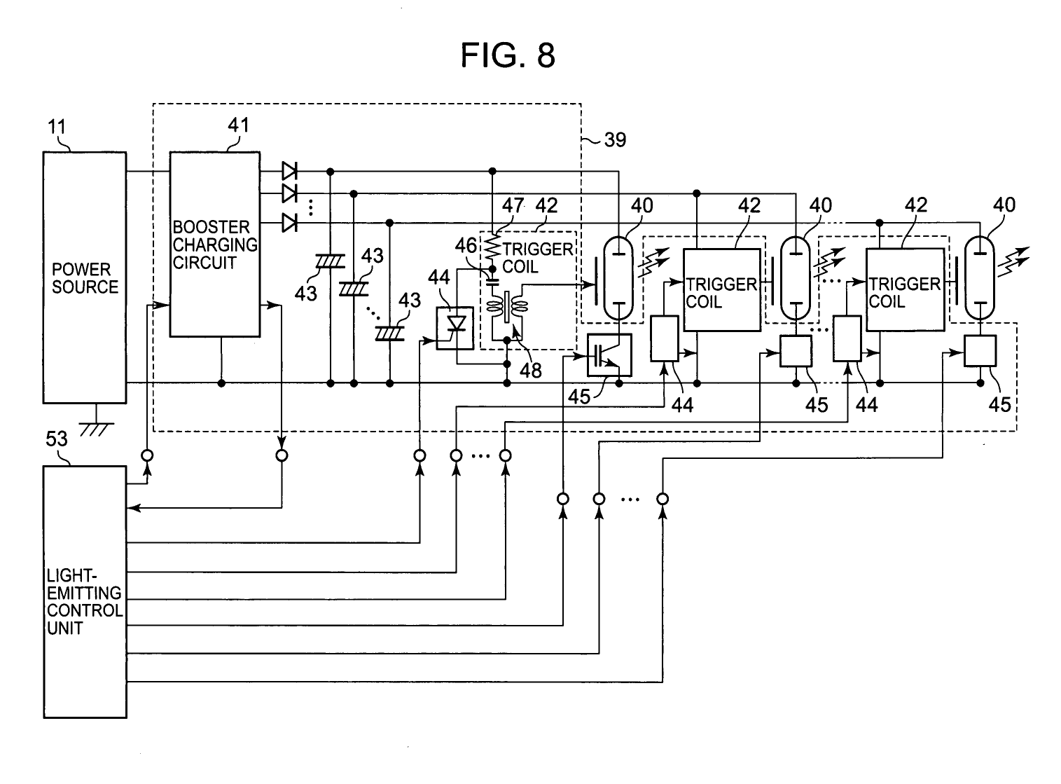

FIG. 8 is a circuit diagram showing a flash light unit using light-emitting members such as Xenon lamp.

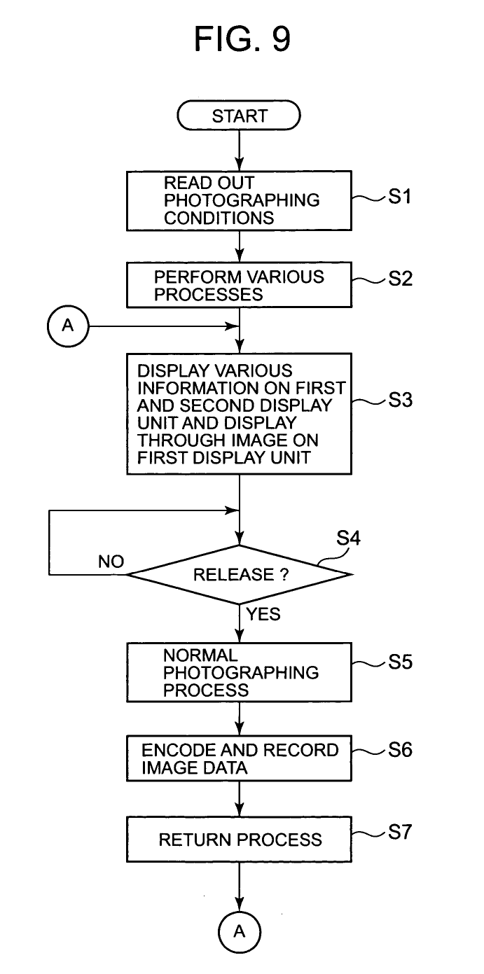

FIG. 9 is a flow chart exemplarily showing processes performed in a normal photograph mode.

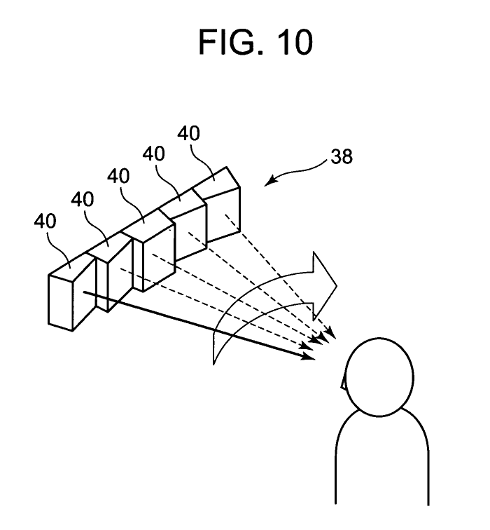

FIG. 10 is a schematic view showing another arrangement of the light-emitting members.

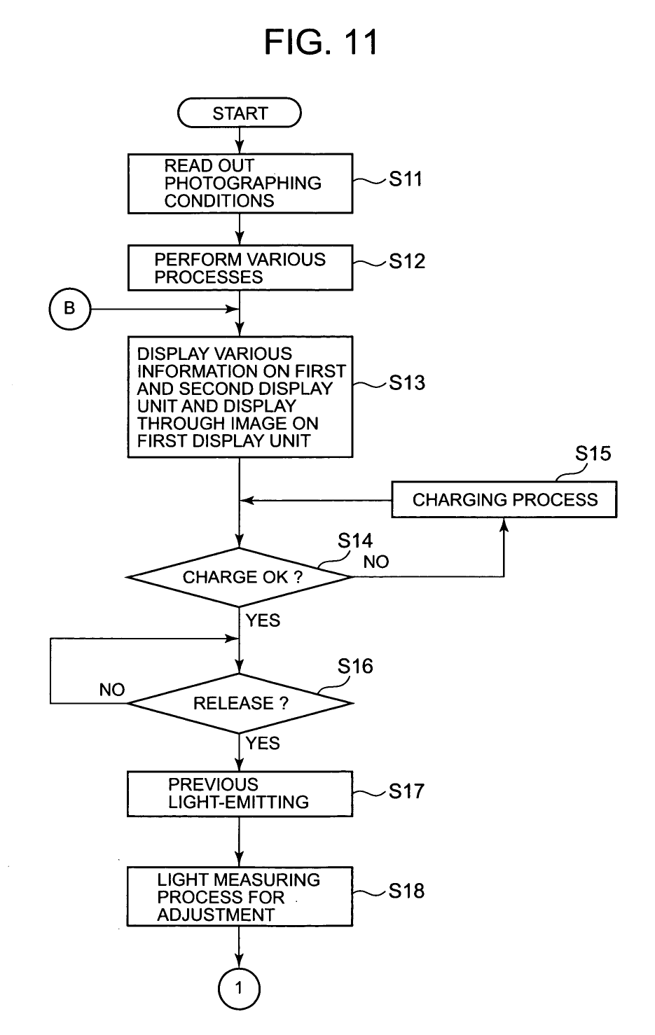

FIG. 11 is a flow chart exemplarily showing processes (1) performed in a strobe bracketing photography.

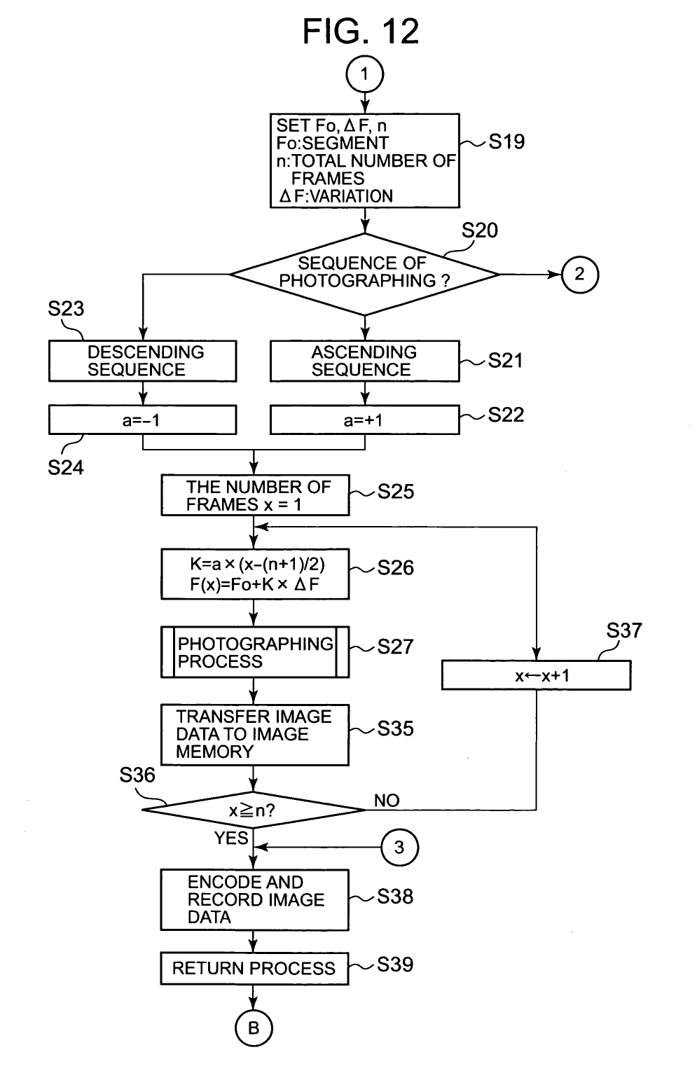

FIG. 12 is a flow chart exemplarily showing processes (2) performed in the strobe bracketing photography.

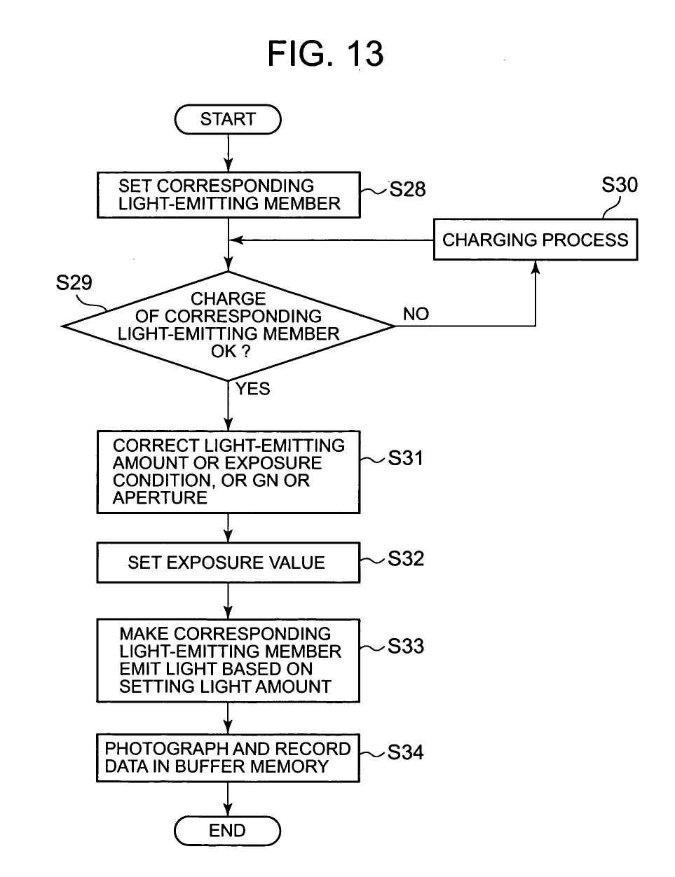

FIG. 13 is a flow chart of a subroutine process performed in the strobe bracketing photography.

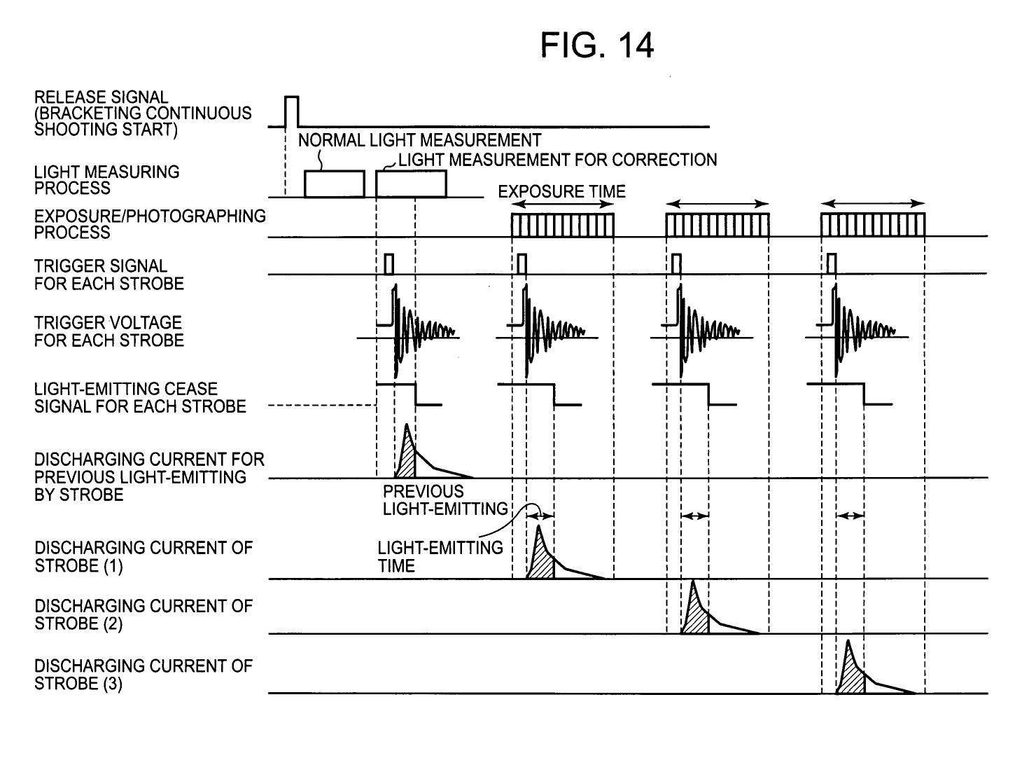

FIG. 14 is a timing chart showing driving operation performed by the flash light unit using light-emitting members such as Xenon lamp.

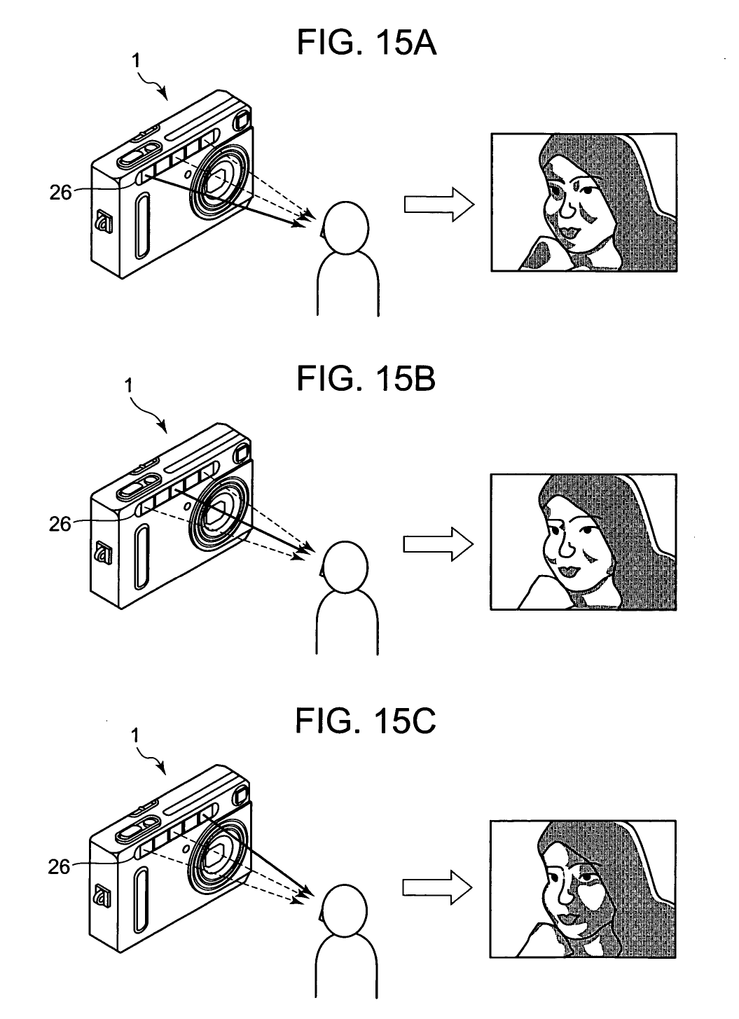

FIG. 15 is a schematic view illustrating strobe bracketing photographing operation.

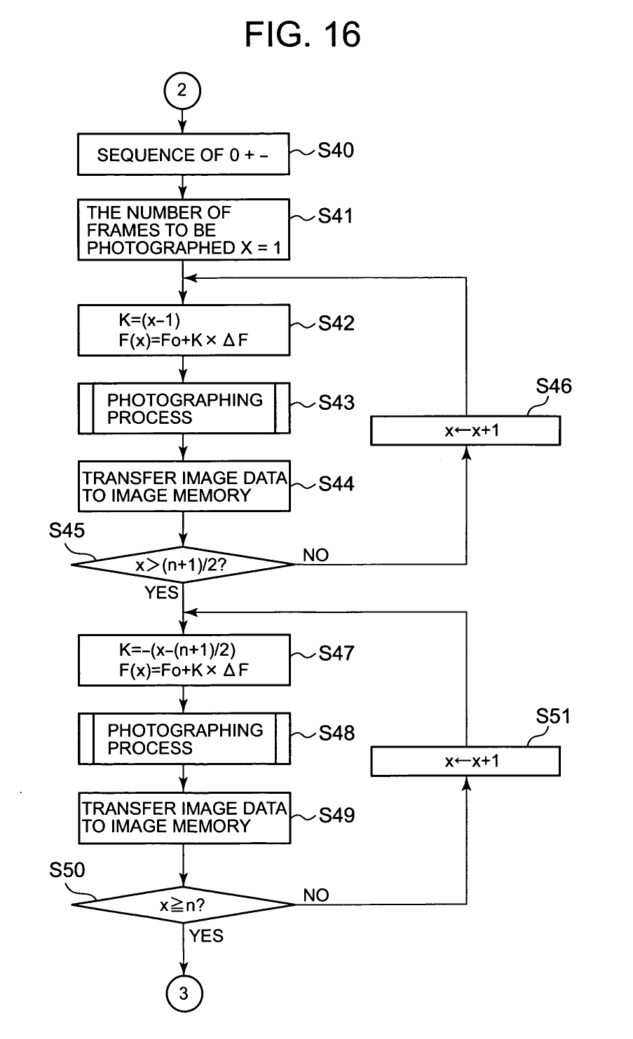

FIG. 16 is a flow chart illustrating processes performed in the strobe bracketing photography.

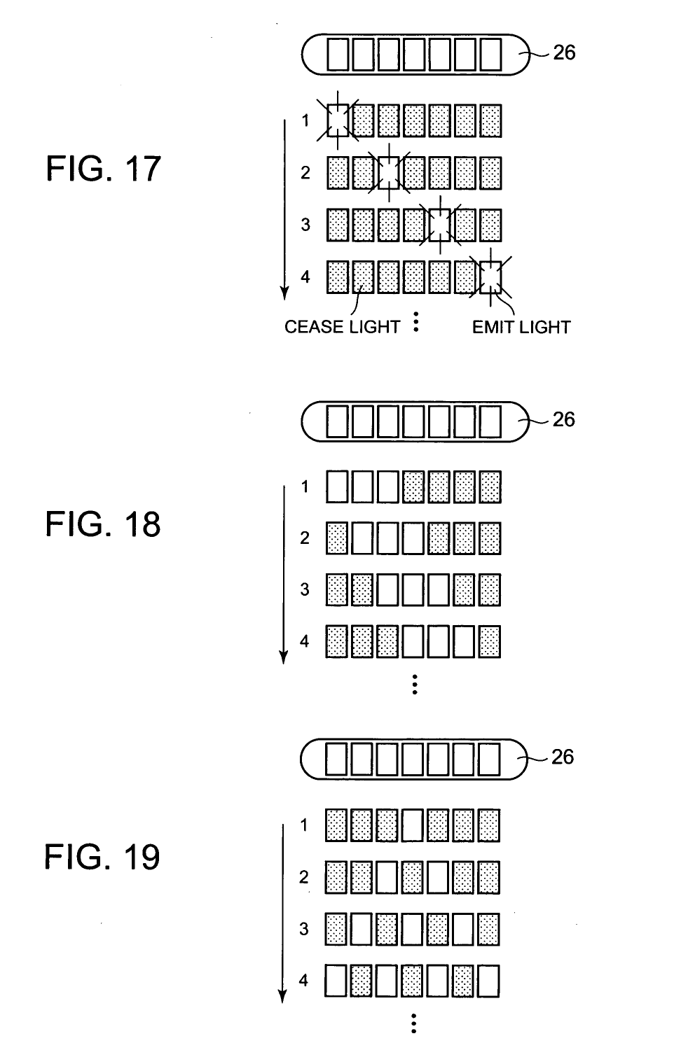

FIG. 17 is a schematic view illustrating a light-emitting pattern in the light-emitting unit.

FIG. 18 is a schematic view illustrating another light-emitting pattern in the light-emitting unit.

FIG. 19 is a schematic view illustrating other light-emitting pattern in the light-emitting unit.

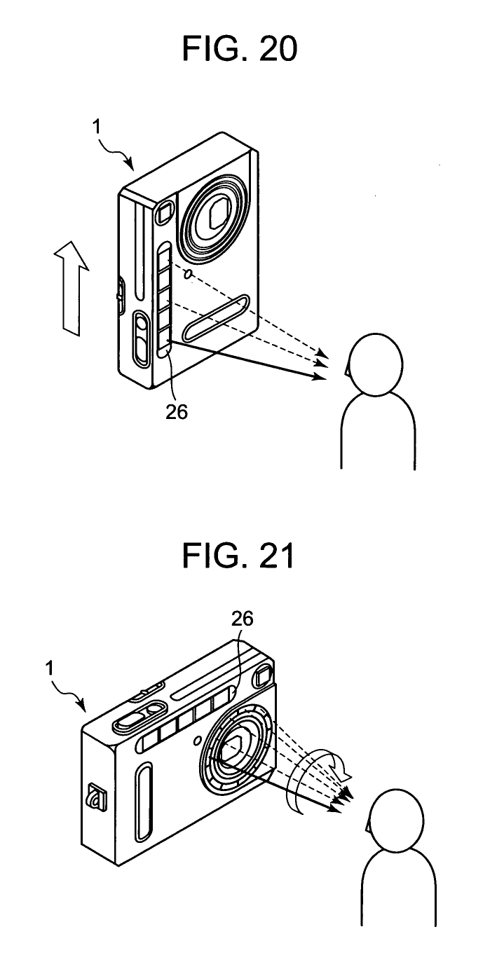

FIG. 20 is a schematic view illustrating the digital camera equipment used, which is turned by 90 degrees from the normal use position.

FIG. 21 is a schematic view illustrating the digital camera equipment used, which is provided with the flash light unit using light-emitting members such as Xenon lamp.

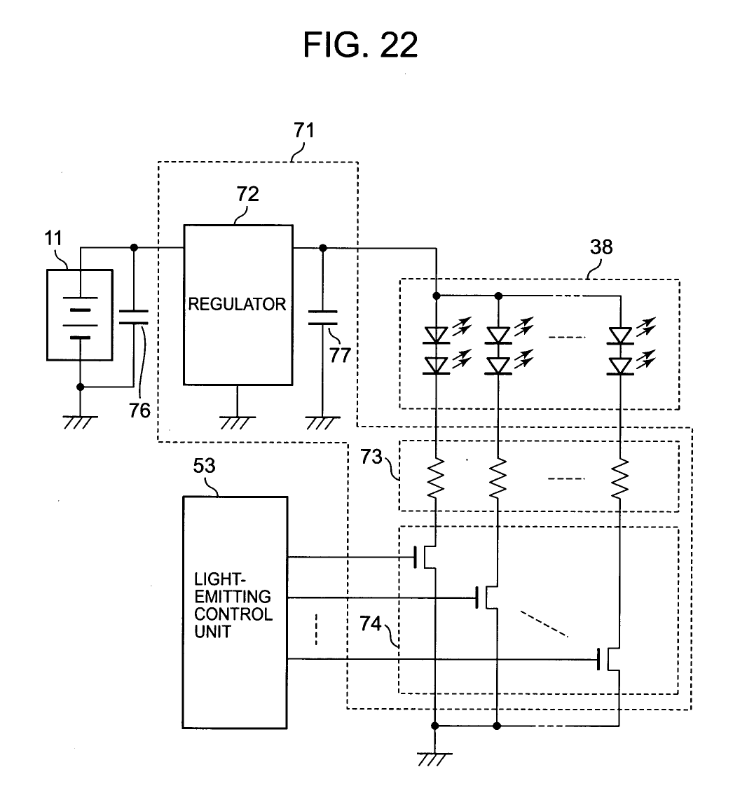

FIG. 22 is a block diagram illustrating a circuit configuration of a flash light unit using light-emitting members such as LED.

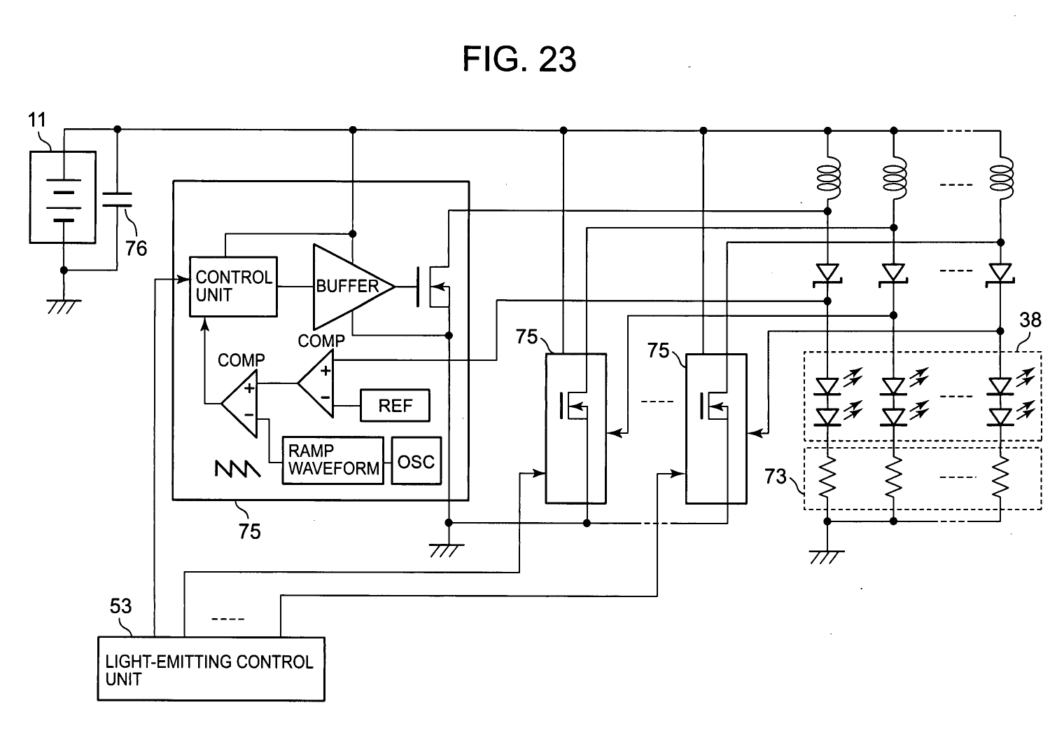

FIG. 23 is a block diagram illustrating another circuit configuration of the flash light unit using light-emitting members such as LED.

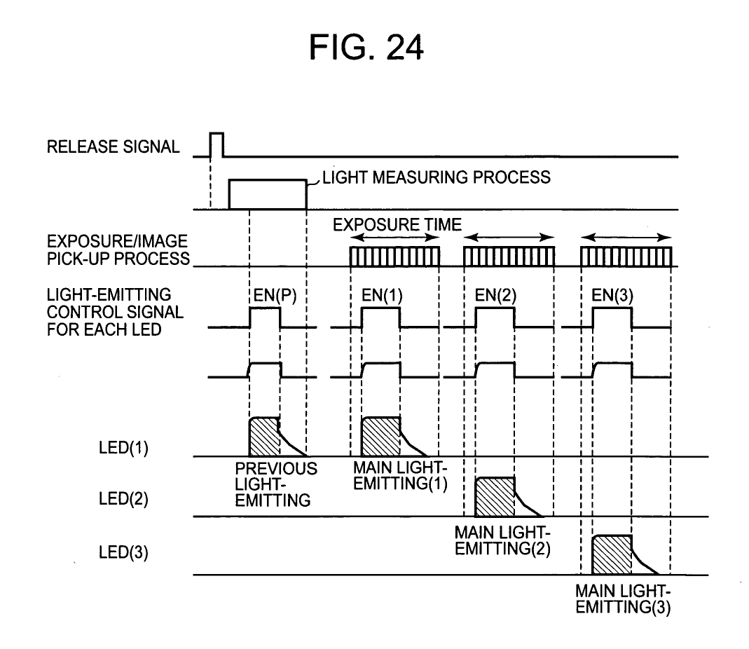

FIG. 24 is a timing chart showing driving operation performed by the flash light unit using light-emitting members such as LED.

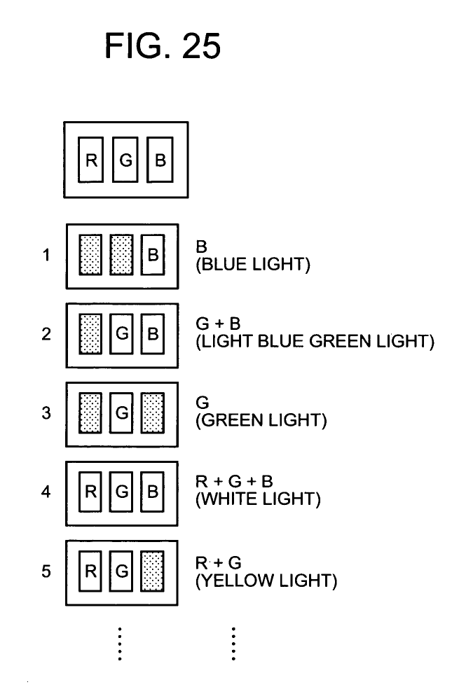

FIG. 25 is a schematic view illustrating a light-emitting pattern of the flash light unit comprising red, green and blue LED in combination.

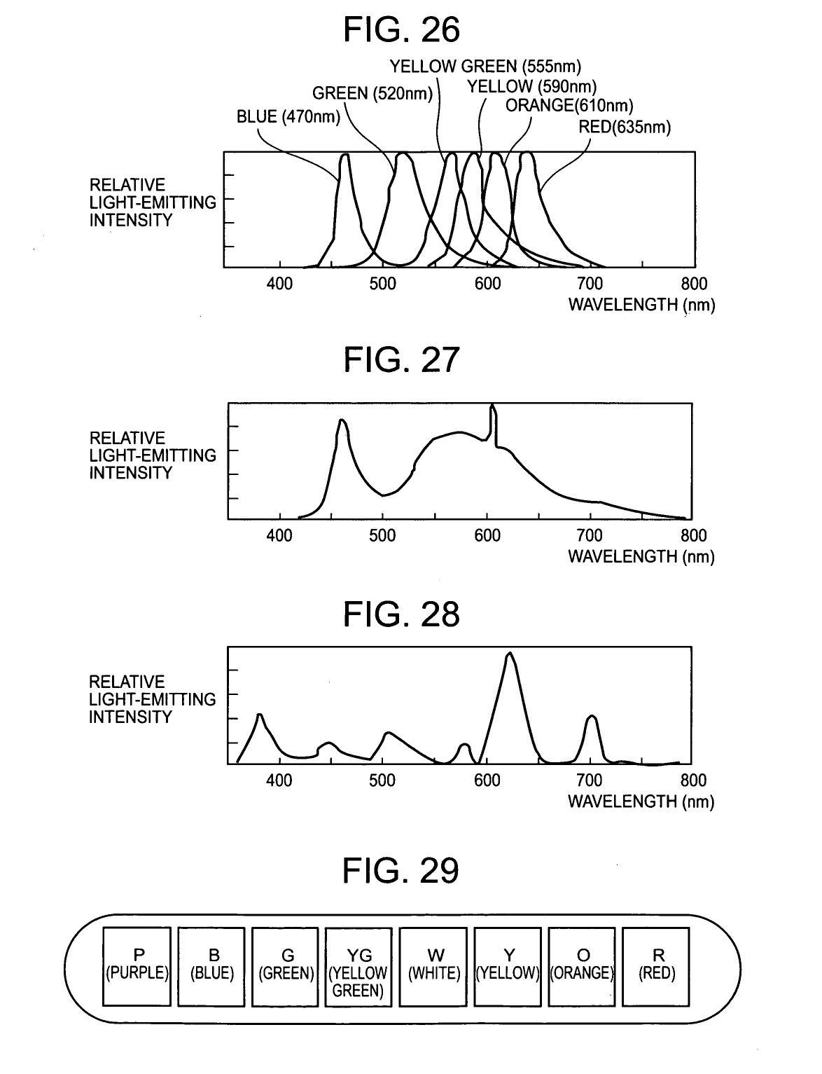

FIG. 26 is a spectrum chart illustrating relationship between relative light emitting intensities and wavelengths of LEDs having blue, green, yellow green, yellow, orange and red characteristic.

FIG. 27 is a spectrum chart illustrating relationship between relative light emitting intensity and a wavelength of white light generated in a pseudo manner by a blue LED and yellow and yellow fluorescent material in combination.

FIG. 28 is a spectrum chart illustrating relationship between relative light emitting intensity and a wavelength of white light generated in a pseudo manner by ultraviolet LED, red, green and blue LED in combination.

FIG. 29 is a schematic view illustrating an arrangement of the light-emitting unit using LEDs.

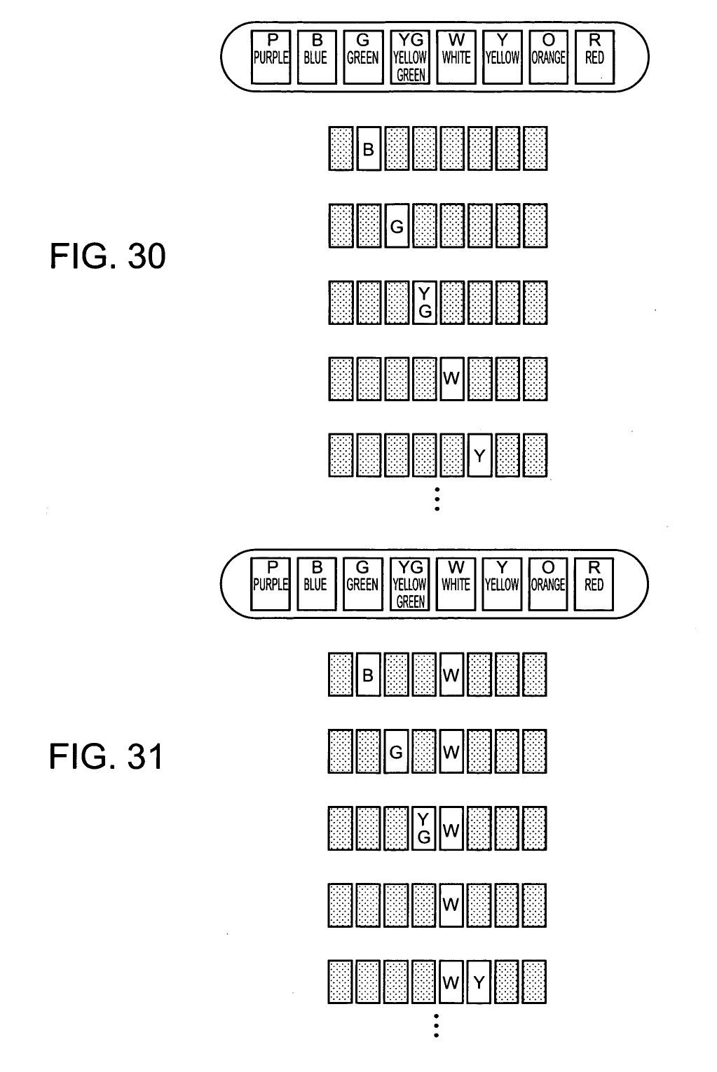

FIG. 30 is a schematic view illustrating a light-emitting pattern of the light-emitting unit shown in FIG. 29.

FIG. 31 is a schematic view illustrating another light-emitting pattern of the light-emitting unit shown in FIG. 29.

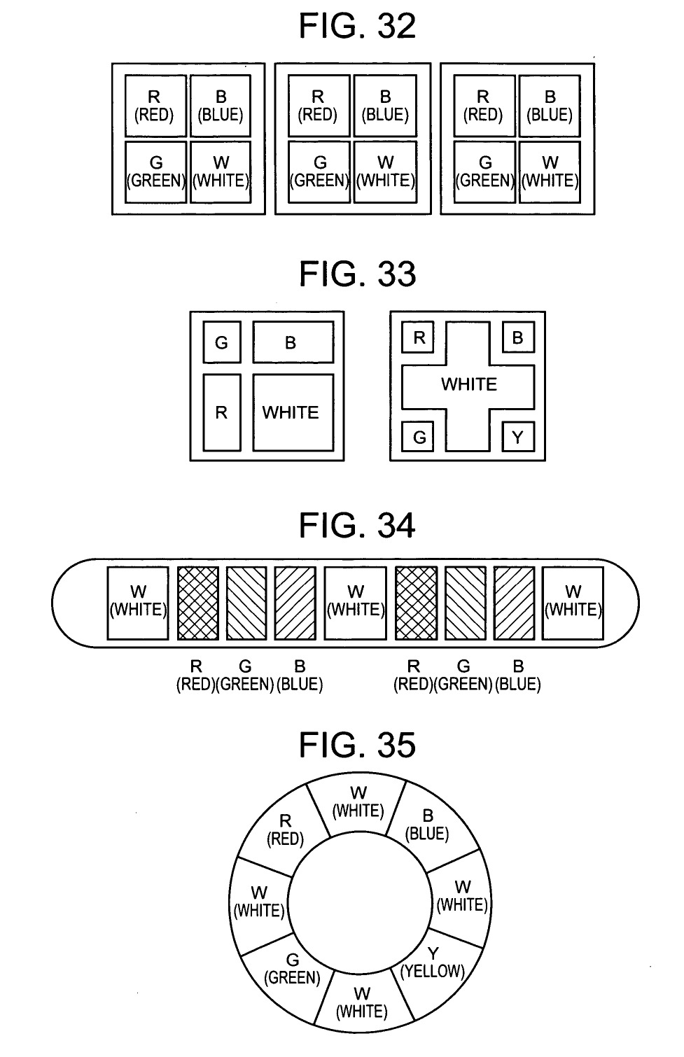

FIG. 32 is a schematic view illustrating another arrangement of the light-emitting unit using LEDs.

FIG. 33 is a schematic view illustrating still another arrangement of the light-emitting unit using LEDs.

FIG. 34 is a schematic view illustrating other arrangement of the light-emitting unit using LEDs.

FIG. 35 is a schematic view illustrating still other arrangement of the light-emitting unit using LEDs.

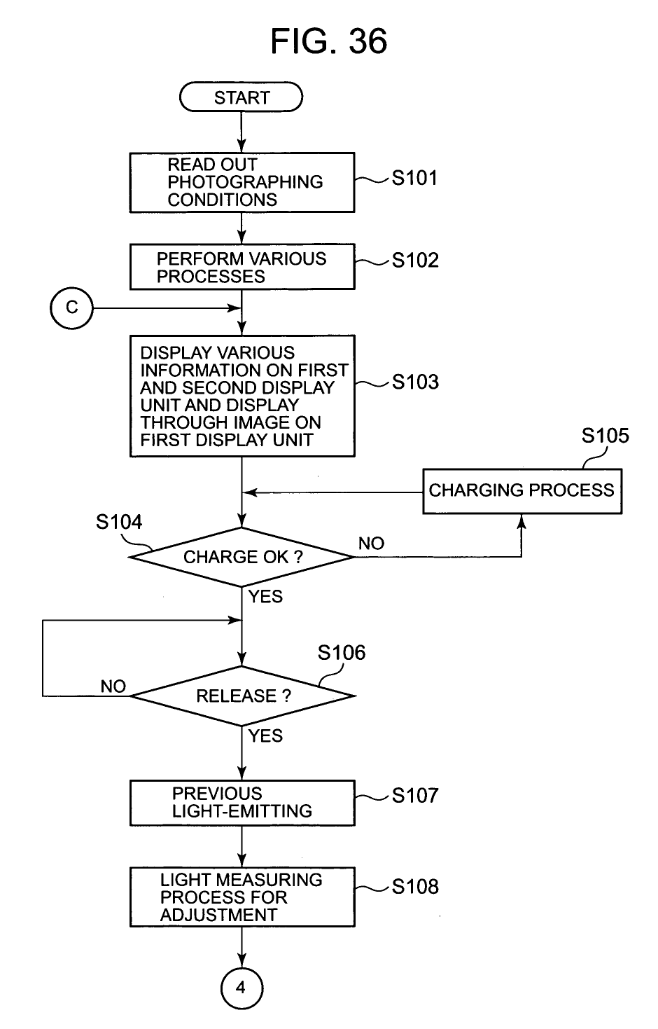

FIG. 36 is a flow chart of processes (1) of continuous shooting with combination of exposure and illumination angles corrected.

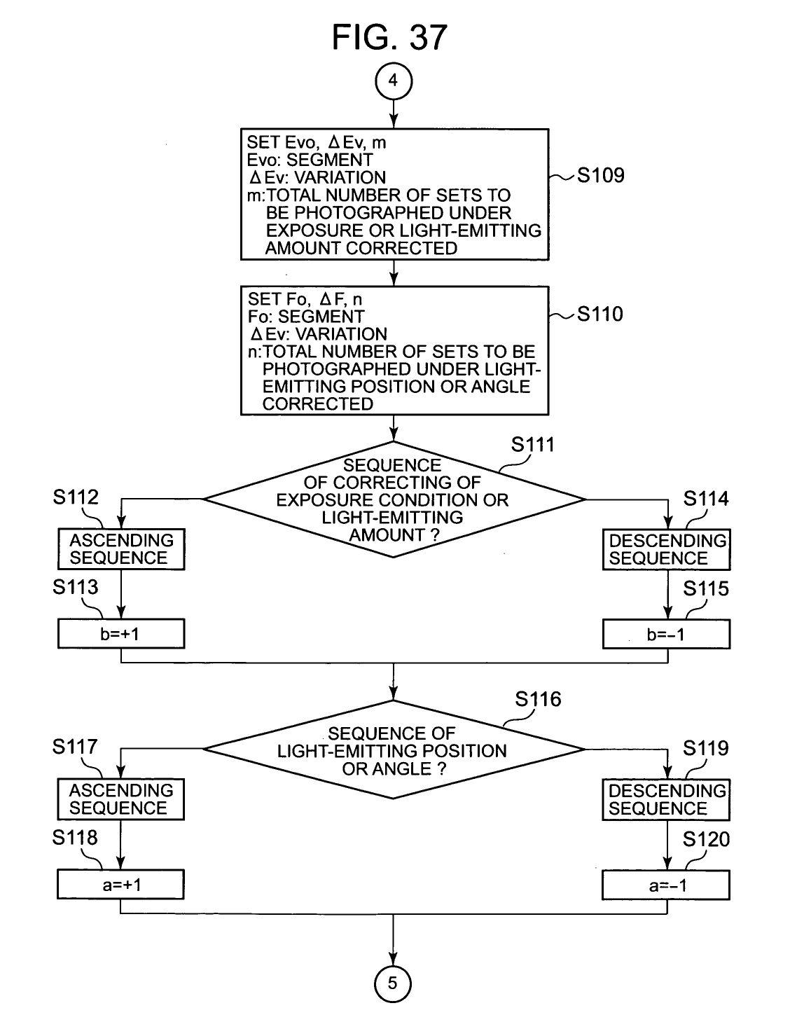

FIG. 37 is a flow chart of processes (2) of continuous shooting with combination of exposure and illumination angles corrected.

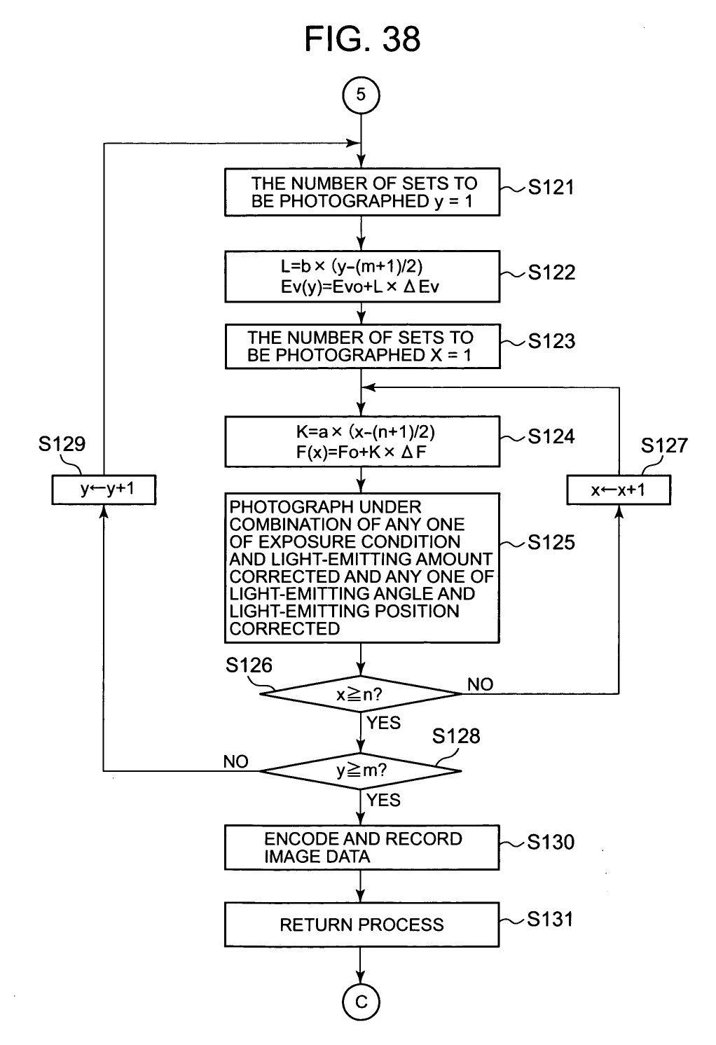

FIG. 38 is a flow chart of processes (3) of continuous shooting with combination of exposure and illumination angles corrected.

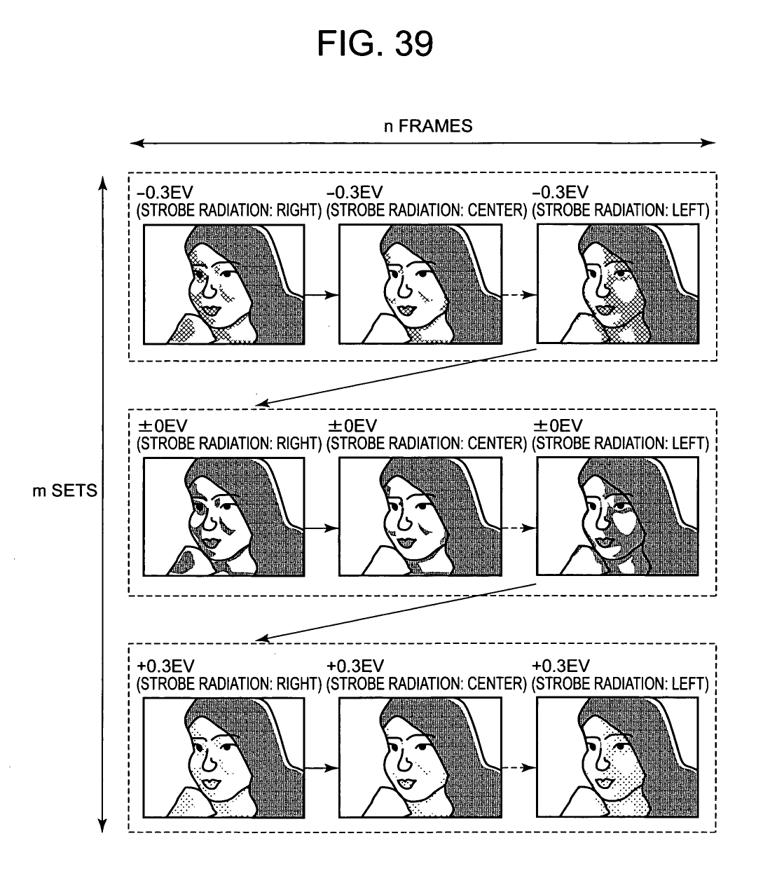

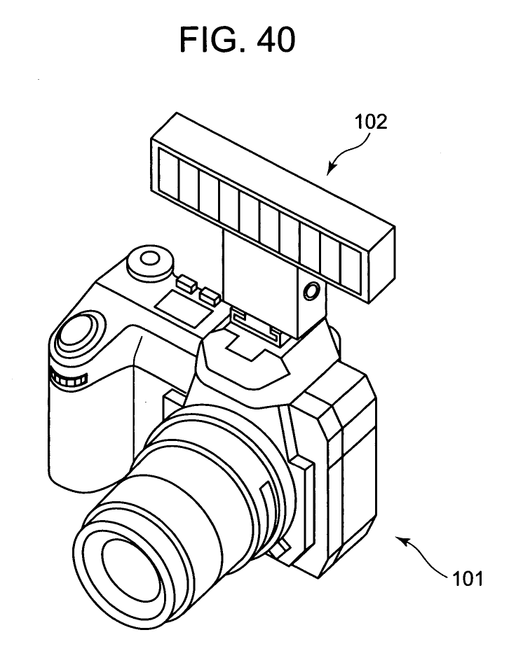

FIG. 39 is a schematic view illustrating continuous shooting with combination of exposure and illumination angles corrected.

FIG. 40 is a perspective view showing digital camera equipment with a flash light unit externally attached thereto.

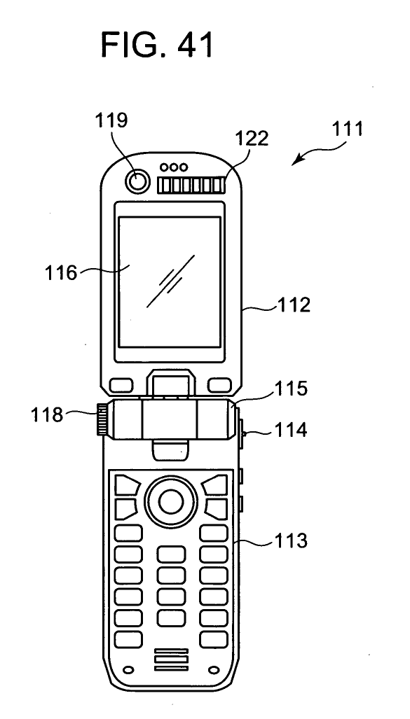

FIG. 41 is a front view of a cellular phone provided with a flash light unit.

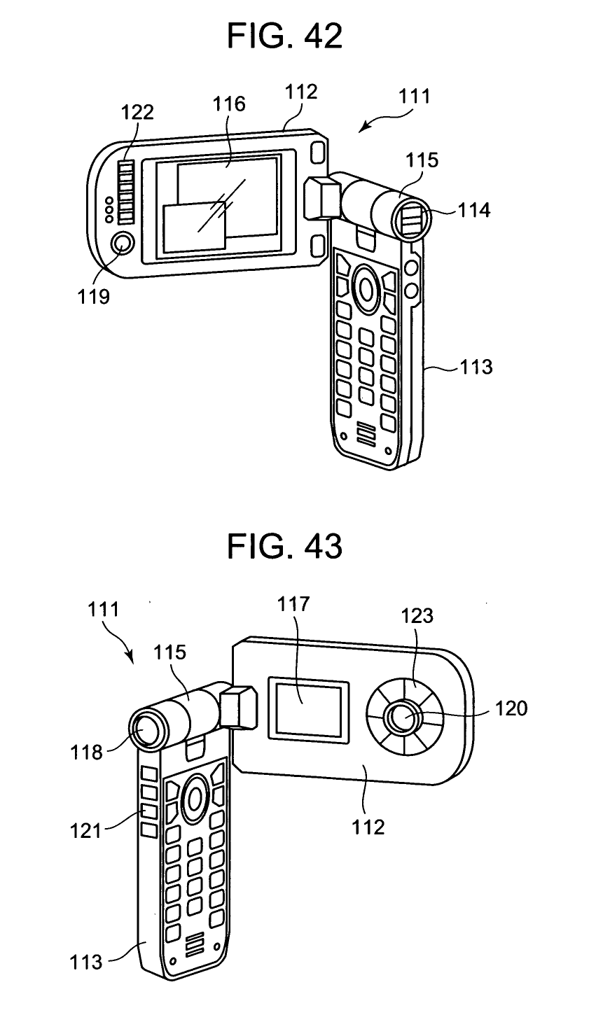

FIG. 42 is a perspective view illustrating a state of the cellular phone provided with a flash light unit.

FIG. 43 is a perspective view illustrating another state of the cellular phone provided with a flash light unit.

### EMBODIMENTS OF THE INVENTION

Now, the best embodiments for carrying out the invention will be described with reference to the accompanying drawings. The embodiments to be described hereinafter include various technically preferable restrictions added thereto, but the scope of the invention should not be limited to the embodiments with these restrictions or exemplarily illustrated embodiments. An image pick-up equipment of the present invention includes a digital camera, cellular phone, and the like. In the embodiment or its modification, the digital camera and cellular phone will be described in detail.

A digital camera or the image pick-up equipment of the present invention will be described with reference to FIG. 1 to FIG. 40.

Referring to FIG. 1 to FIG. 8, a configuration of the digital camera 1 according to the embodiment of the present invention will be described.

As shown in FIG. 1, the digital camera 1 according to the embodiment of the invention has a housing 2 formed in a generally rectangular block. On an upper surface of the housing 2 are provided a power button 3, mode switching unit 4, and shutter button 5.

The power button 3 is a push button switch, which turns on or off the power in an alternate manner, when depressed.

The mode switching unit 4 is a slid switch, which is slidable in a determined direction. The digital camera 1 according to the embodiment of the invention has a “photograph-mode” and “play-back mode” as illustrated in FIG. 5. A user can switch operation mode from the photograph mode to the play-back mode and vice versa by operating the mode switching unit 4.

The shutter button 5 is a push button, and gives an instruction of release the shutter when depressed in the photograph mode. The shutter button is arranged to give an instruction of executing a command on a guide screen or selection screen in the play-back mode or setting mode, when depressed. An electric signal from the shutter button 5 is sent to an input circuit 6 provided in the housing 2, as shown in FIG. 6.

As illustrated in FIG. 3 to FIG. 6, on a bottom portion of the housing 2 are provided a plate-like cover 7 which can be opened, and a communication unit 8. The housing 2 is provided with two hollow storage portions 9, 10 inside the cover 7, in which storage portions a power battery 11 and a recording medium 12 such as a memory card are detachably received, respectively.

The battery storage portion 9 is electrically connected to a power-source control unit 13. Therefore, the battery 11 received therein can supply current to the power-source control unit 13. The memory storage portion 10 is provided with a recording medium I/F 14. Through the recording medium I/F 14, image data and the like are exchanged between the digital camera 1 or camera equipment and the recording storage 12 received in the storage portion 10.

The communication unit 8 is provided with an input-output I/F 15, communication I/F 16 such as USB, and LAN. Through the input-output I/F 15, image data and the like are exchanged between the camera equipment 1 and an external device connected to the communication I/F 16.

On a rear surface of the housing 2, there are provided a first display unit 17, optical finder 18, operation button 19, guidance display button 20, and screen-display button 21, as shown in FIG. 3. The first display unit 17 comprises a Liquid Crystal Display (LCD), which serves as an electronic finder for displaying an object and various information such as photographing information relating to photographing conditions and setting information in the photograph-mode, and which displays various guidance screens or instruction screens, or a selected image. Further, the first display unit 17 is provided with a touch panel function for a user to input various instructions with his or her finger or a pen.

The optical finder 18 comprises a second display unit 22, a finder mirror 23 and a finder lens 24, as shown in FIG. 6. On the second display unit 22 are displayed the photographing information or setting information together with composition of an image to be photographed and a focal length. These sorts of information including the image are inverted by the finder mirror 23 and visually confirmed by the user through the finder lens 24. As described above, since the first and second display unit 17, 22 display the photographing information and setting information, the user can used the equipment very conveniently.

As described above, the photograph mode and play-back mode can be switched by sliding operation of the mode switching unit 4. As illustrated in FIG. 5, a “normal photograph mode” and a “bracket photograph mode” are prepared for the photograph mode. In the initial state where the photograph mode is set, the normal photograph mode is selected. The operation button 19 shown in FIG. 3 consists of a cross key which can be depressed at four or cross positions around its center, and is arranged for selecting a command displayed in the guidance screen or instruction screen when depressed. When depressed at the left position in the normal photograph mode, the cross key switches from the normal photograph mode to the bracket photograph mode, and when depressed at the left position in the bracket photograph mode, the cross key switches from the bracket photograph mode to the normal photograph mode.

The guidance-display button 20 is a push-button switch. When depressed, the guidance-display button 20 switches between the photograph mode (play-back mode) and the setting mode for setting a photographing condition. More specifically, the camera equipment 1 according to the embodiment of the invention has three sorts of setting modes including “normal photograph setting mode”, “bracket photograph setting mode”, and “play-back setting mode”. These setting modes are switched as follows. When the guidance-display button 20 is depressed in the normal photograph mode, the normal photograph mode is switched to the normal photograph setting mode, and when the guidance-display button 20 is depressed in the normal photograph setting mode, the normal photograph setting mode is switched to the normal photograph mode.

Further, when the guidance-display button 20 is depressed in the bracket photograph mode, the bracket photograph mode is switched to the bracket photograph setting mode, and when the guidance-display button 20 is depressed in the bracket photograph setting mode, the bracket photograph setting mode is switched to the bracket photograph mode.

In the similar manner, when the guidance display button 20 is depressed in the play-back mode, the play-back mode is switched to the play-back setting mode, and when the guidance-display button 20 is depressed in the play-back setting mode, the play-back setting mode is switched to the play-back mode.

The screen-display button 21 consists of a push-button switch. By depressing the screen-display button 21, the user can select whether to display various sorts of information or to display a through image on the first display unit, or select sorts of information to be displayed thereon.

On a front surface of the housing 2, there are provided an image pick-up unit 25 and flash light-emitting unit 26, as shown in FIG. 1 and FIG. 4.

The image pick-up unit 25 comprises a lens unit 27, mirror unit 28, shutter 29, and image pick-up element 30. These units are arranged along the axis of light flux or beam (hereinafter, referred to as “beam”) entered from the front surface of the housing 2 in the order of lens unit 27, mirror unit 28, shutter 29 and the image pick-up element 30.

The lens unit 27 comprises an optical image pick-up lens system 31 and a single measurement lens 32. The image pick-up lens system 31 further comprises six spherical lenses including two sets of doublet lenses, each of which consists of a combination of a convex lens and concave lens stacked together. The lenses in the image pick-up lens system 31 are provided with a lens driving unit 33 to be adjusted their positions along the optical axis of beam, whereby the focal length is adjusted. Further, the image pick-up lens system 31 has an aperture mechanism 34 provided between certain lenses. To adjust an amount of beam entering into the housing 2, the aperture mechanism 34 has an aperture which can be adjusted in accordance with movement of plural aperture rings (not shown) which are disposed petaloid like and connected to a connecting ring (not shown).

The measurement lens 32 is provided within the housing 2, and a detecting unit 35 is provided behind the measurement lens 32 to allow the beam to enter into the housing 2. The detecting unit 35 detects beam amount and beam intensity based on the beam entered into the housing 2.

The mirror unit 28 comprises a main mirror 36 and subsidiary mirror 37, the surfaces of both mirrors being subjected to mirror-like finishing.

The main mirror 36 is disposed so as to intersect with the optical axis of the beam at a certain angle, and to turn upward about one end of the rear surface of the mirror 36 at the time when the shutter button 5 is depressed. The main mirror 36 has a semi-transparent portion. Most of the beam entered to the main mirror 36 through the image pick-up lens system 31 is reflected on the main mirror 36 toward the second display unit 22, but a part of the beam entered to the semi-transparent portion is guided to a plane opposite to the incidence plane to be output against the subsidiary mirror 37.

The beam passing through the main mirror 36 is guided to the subsidiary mirror 37 to be output to the detecting unit 35.

The shutter 29 serves as an electronic shutter, open or close operation, or a running speed of which is controlled based on an electric signal. When beam amount entering through the lens unit 27 is not sufficient, a driving mechanism (not shown) controls the running speed to adjust open-close time of the shutter 29, or a time duration in which the beam enters into the image pick-up element 30.

A vertically running shutter system which opens or closes in the vertical direction or a horizontally running shutter system which opens or closes in the horizontal direction may be employed as an open-close system of the shutter 29. The shutter used in the present embodiment is an electronic shutter, but is not limited to this shutter and a mechanical shutter which is mechanically controlled may be used.

The image pick-up element 30 comprises an image sensor such as CCD (Charge Coupled Device), CMOS (Complementary Metal Oxide Semiconductor), and the like, which converts an optical image of an object entered through the image pick-up lens system 31 of the lens unit 27 into an electric signal and outputs same.

The flash light-emitting unit 26 comprises a light-emitting unit 38 and a light-emitting member driving unit 39, as illustrated in FIG. 6.

The light-emitting unit 38 further comprises plural light-emitting members 40. As these light-emitting members 40, for example, are used flash-light discharging bulbs such as a xenon lamp, which are disposed in a longitudinal direction.

It should be noted that the light-emitting unit 26 is not limited to arrangement of the plural light-emitting members but may be a single light-emitting member which is divided into plural sections.

As shown in FIG. 8, the light-emitting member driving unit 39 comprises a booster charging circuit 41, plural trigger coils 42, plural main capacitors 43, plural trigger switches 44, and plural light-emit ceasing switching elements 45. The booster charging circuit 41 works to raises battery voltage of 3.0 to 4.2 volts to about 330 volts, and supplies to the main capacitors 43 serving as an accumulator.

The trigger coil 42 includes trigger capacitor 46, trigger resistor 47, and coil 48. Charge stored in the main capacitor 43 and the trigger capacitor 46 is simultaneously discharged through the primary coil of the coil 48 to generate a trigger voltage of about 3300 volts at the secondary coil of the coil 48.

The main capacitors 43 are provided for the light-emitting members 40, respectively, and charged by voltage of the booster charging circuit 41.

The trigger switch 44 comprises a thyristor having high voltage resistance and high speed characteristic, power FET (Field Effect Transistor), or IGBT (Insulated Gate Bipolar Transistor). The light-emitting ceasing switching element 45 works in response to a trigger signal.

The light-emitting ceasing switching element 45 comprises a switching element of high voltage resistance, and outputs a light-emitting ceasing signal to the trigger coil 42.

Each light-emitting member 40 is provided with the light-emitting member driving unit 39 including one trigger coil 42, main capacitor 43, trigger switch 44 and light-emitting ceasing switching element 45. In other words, one circuit combination consists of a light-emitting member 40, trigger coil 42, main capacitor 43, trigger switch 44 and light-emitting ceasing switching element 45.

Within the housing 2, there is provided a photograph-control unit 49, as shown in FIG. 6. The photograph-control unit 49 comprises an operation-control unit 50, input-image processing unit 51, measuring unit 52 and light-emitting control unit 53.

The operation-control unit 50 outputs an electric signal to make the lens-driving unit control a certain lens in an image pick-up lens system 31 so as to adjust a focal length. Further, operation-control unit 50 controls the connecting ring of the aperture mechanism 34 and the driving mechanism of the shutter 29 to adjust spherical aberration of lens and the running speed of the shutter 29.

The input-image processing section 51 comprises CDS (Correlated Double Sampling)/AGC (Automatic Gain Control) circuit and A/D converter circuit (both not shown). CDS/AGC circuit eliminates noises included in an electric signal output from the image pick-up element 30 and, when the level of the electric signal from the image pick-up element 30 is low due to short of an exposure time, amplifies the signal up to an appropriate level. The amplified signal is supplied to A/D converter circuit.

A/D converter circuit converts input analog image data into digital image data.

The measuring section 52 calculates a measured light value, measured distance and color temperature based on beam amount and beam intensity detected by the detecting unit 35.

The light-emitting control unit 53 outputs an electric signal to the light-emitting member driving unit 39 to control the number of times of light emitting by the light-emitting unit 38, interval of the light emitting, position of the light emitting, and light emitting angle against the object from the light emitting position. The light-emitting control unit 53 may be modified so as to control light-emitting amount and light-emitting time duration based on measured light amount in previous light emitting or measured light amount in main light emitting. The previous light emitting is to previously emit light against the object for a short time.

The photograph-control unit 49 is connected to a control unit 54 including CPU (Central Processing Unit). The photograph-control unit 54 calculates and processes input data to obtain an appropriate exposure amount from the measured light amount in accordance with photographing conditions set by the user. The control unit 54 is connected with a storage unit 55, image processing unit 56, compression processing unit 57, and display control units 58, 59.

The storage unit 55 comprises a volatile RAM (Random Access Memory) for temporarily storing information and a non-volatile ROM (Read Only Memory) for storing information. In ROM are stored various sorts of system programs, application programs and data.

RAM has a program area for expanding a program and a data area for storing data supplied from the operation button 19 and various processing results obtained by the control unit 54.

In the data area are separately provided a buffer memory which has a small storage area but is of a high writing speed and an image memory which has a large storage area but is of a low writing speed.

The image processing unit 56 performs various image processing processes, including an image complementation process, gamma correction, and the like, on image data signal obtained by the image pick-up element 30.

The compression processing unit 57 compresses and codes image data and expands and decodes the image data in conformity with various data compression standards such as JPEG (Joint Photographic Expert Group), MPEG 4 (Moving Picture Expert Group) and TFII (Tagged Image File Format).

The display control units 58, 59 are a first display control unit 58 and a second display control unit 59. The display control units 58, 59 convert image data supplied from the photograph-control unit 49 into a video signal, based on a display signal input from the control unit 54, and output the video signal to the first display unit 17 and the second display unit 22, respectively. The first display unit 17 is provided with a display memory 60 for temporarily storing digital image data.

Now, operation of the digital camera 1 or camera equipment according to the embodiments of the invention will be described with reference to FIG. 9.

When the photograph-mode is set by depressing the guidance display button 20, then the normal photograph mode is automatically selected. As shown in FIG. 9, the photographing conditions (for example, anyone of “compulsion light emitting”, “light emitting prohibition”, and “automatic light emitting” is selected as the light emitting condition) are read out at step S1, and various processes are executed based on the photograph conditions at step S2.

After the various processes have been executed, various sorts of information are displayed on the first and second display unit 17, 22, and a through image together with various sorts of information are displayed on the first display unit 17 at step S3. Viewing the through image displayed on the first display unit 17, the user decides camera angle of the camera equipment 1.

Thereafter, the user judges at step S4 whether to depress the shutter button 5. When the user does not depress the shutter button 5 (NO at step S4), then he or she is given another opportunity at step S4 to judge whether to depress the shutter button 5. When the user depresses the shutter button 5 (YES at step S4), a normal photographing process is performed at step S5, and image data taken by the image pick-up unit 25 is output to the first display unit 17 through the input image processing section 51 and control unit 54, and simultaneously stored in the internal storage 55 or in the detachable recording storage 12 received therein at step S6. Then, a series of photographing operations have been completed.

Thereafter, a return process is performed at step S7, and the operation returns to step S3, where various sorts of information are updated and displayed on the first and second display unit 17, 22, and also a through image is displayed on the first display unit 17 together with the various sorts of information.

As shown in FIG. 10, the plural light-emitting members 40 of the light-emitting unit 38 are disposed at different positions, and installed so as to have different optical axes (light emitting angles). When photographing operations (hereinafter, “strobe bracketing photography”) are performed in success with a light emitting position or light emitting angle adjusted by selecting an arbitrary light-emitting member among the plural light-emitting members, various conditions have to be set before such photographing operations are performed. Now, a method of setting the photographing conditions (hereinafter, “bracket conditions” including light emitting conditions) and operation for performing the strobe bracketing photography will be described in detail with reference to FIG. 11 to FIG. 15.

First, the operation button 19 or the cross key is depressed at its left position in the normal photograph mode to switch to the bracket photograph mode. Then, the guidance display button 20 is depressed in the bracket photograph mode to switch to the bracket photograph setting mode, in which the bracket conditions such as a correction interval, correction order or photographing order, and total number of frames (odd number) are set to desired values.

With respect to the correction interval, variation amounts in a position of the light-emitting member 40 emitting light in the light-emitting unit 38, and a light emitting angle of the light-emitting member 40 (light emitting conditions) can be set for each photographing operation.

With respect to the correction order or photographing order, ascending sequence (plus direction, from right to left side of the object), descending sequence (minus direction, from left to right side of the object), “0+−” sequence (from center to left side, from left to right side) or “0−+” (from center to right side, from right to left side) can be selected and set. For example, assuming that “0” is the initial condition with no correction made, when the number of frames is set to three in the ascending sequence, photographing operations are performed under photograph conditions where the light emitting position or light-emitting angle is changed in order of “−1 correction”, “0: no correction”, and “+1 correction”. Consequently, assuming in the strobe bracketing photography that the bracket conditions are set as follows: a segment is “F0”, a variation is [symbol] the photographing sequence is “ascending sequence”, and the total number of frames is “n”, then, the continuous shooting is performed in accordance with the following equation (1) in order of conditions, “F0− [symbol] , “F0”, and “F0+ [symbol] .

Further, the photographing sequence is set to the “descending sequence”, the continuous shooting is performed in accordance with the following equation (1) in order of “F0+ [symbol] , “F0”, and “F0− [symbol] .
F(x)=F0+K× (1)
where F(X) is a light emitting position or light emitting angle, and, for example, F(1) represents photographing condition for the first frame, “X” denotes the order of photographing, and “K” is given by [X−(n+1)/2] in the ascending sequence, and “K” is given by −[X−(n+1)/2] in the descending sequence.

Further, when the number of frames to be photographed is set to five, and the photographing order is set to “0+−” in the bracket conditions, the continuous shooting is performed in order of conditions “0: no correction”, “+1 correction”, “+2 correction”, “−1 correction”, and “−2 correction”. In other words, the first frame is photographed under the condition with no correction made, and then photographing operations are performed in accordance with the equation (1).

When the photographing order is set to “0+−”, “K” in the equation (1) is given by “X−1”, when X≦(n+1)/2, and given by −[X−(n+1)/2], when X>(n+1)/2.

The order of photographing is not limited to the order of “ascending sequence”, “descending order” and “0+−”, but may be set to other proper sequence.

The number of frames to be photographed is set to an odd number such as 1, 3, 5, 7 and so on, but the invention is not limitted to this and such number of frames may be set to an arbitrary positive integer. For example, it is proposed that, when the number of frames is set to eight, the photographing operation is performed, as if the number of frames has been set to nine, and that the process is deemed to have finished at the time when eight frames have been photographed and the last frame is not photographed. In this arrangement, the number of times of light emitting by the flash light unit 26 is set to the number of frames to be actually photographed.

Further, the bracket condition may be set by selecting a predetermined number, or by deleting or adding a number from or to the predetermined number, or may be set by inputting an arbitrary number.

The bracket condition may be set by depressing the operation button 19 in the bracket photograph setting mode, but a separate button which is exclusively used for setting the bracket condition may be provided.

After the bracket condition has been set as descried above, when the bracket photograph setting mode is switched to the bracket photograph mode by depressing cross key at left position, photographing conditions are read out at step S11 in FIG. 11, and various processes are performed at step S12. The photographing conditions read out in the bracket photograph mode are those including exposure conditions previously set in the normal photograph mode and the bracket condition.

Various sorts of information are displayed on the first and second display unit 17, 22, and further a through image is displayed on the first display unit 17 in addition to those displayed thereon at step S13. Thereafter, charged condition of the main capacitor of the light-emitting member driving unit 39 in the flash light unit 26 is displayed on the first and second display unit 17, 22 for confirmation purpose at step S14. When it is confirmed that the main capacitor has not yet been charged sufficiently (NO at step S14), the battery voltage of 3.0 to 4.2 volts is raised to about 330 volts by the booster charging circuit 41 in the light-emitting member driving circuit 39 to further charge the main capacitor 43 at step S15.

Meanwhile, when it is confirmed that the main capacitor has been charged sufficiently (YES at step S14), the user determines whether to operate the shutter button 5 at step S16. When the user does not operate the shutter button (NO at step S16), the user is given another chance to determine whether to operate the shutter button 5 at step S16. When the user operates the shutter button (YES at step S16), an automatic illumination adjusting function makes a part of the light-emitting unit 38 of the flash light unit 26 emit light provisionally at step S17, and executes light measuring process for adjusting illumination upon receipt of reflected light at step S18.

The bracket conditions set in the bracket photograph setting mode, including a segment “F0”, variation [symbol] , total number of frames “n” (odd number) are set sequentially to the light-emitting control unit 53 at step S19. Sequence of photographing is confirmed at step S20. When the ascending sequence is confirmed at step S21, the sequence of photographing “a” is set to “+1” at step S22.

Meanwhile, when the descending sequence is confirmed at step S23, the sequence of photographing “a” is set to “−1” at step S24.

Further, the number of frames “X” is set to “1” at step S25. Values of “K” and “F(X)” are calculated using following equations (2), (3) at step S26, and the photographing process is performed in accordance with these calculation results at step S27.
K=a×[X−(n+1)/2] (2)
F(X)=F0+K× (3)

In the photographing process, a light-emitting member made to emit light is selected in the light-emitting members 40 at step S28, and charged condition of the main capacitor 43 for the selected light emitting member 40 is confirmed at step S29. When it is confirmed that such main capacitor 43 has not yet been charged sufficiently (NO at step S29), a charging process is executed at step S30.

When it is confirmed that the main capacitor 43 of the member made to emit light has been charged sufficiently (YES at step S29), a factor “GN” for setting a light-emitting amount and an aperture value for setting the exposure condition are adjusted based on the photographing conditions previously set and the light measurement value in the provisional illumination so as to satisfy the following equations at step S31.
GN≧F×L/(S/100)½ (4)
where F denotes an aperture value, L denotes a distance to the object, and S represents ISO sensitivity.
F≦GN×(S/100)½ (5)
where F denotes an aperture value, and S represents ISO sensitivity.

After the exposure value has been set based on the exposure condition and light measurement value at step S32, the trigger switches 44 operate in response to the trigger signal from the light-emitting control unit 53 to activate the trigger coil 42 of each of the light-emitting members or flash light discharging tube 40 in the light-emitting unit 38.

Further, electric charge in the trigger capacitor 46 of the trigger coil 42 is discharged through the primary coil of the coil 48 to generate a trigger voltage of about 3300 volts at the secondary coil. The trigger voltage is applied to the flash light discharging tube 40 of the light-emitting unit 38 to cause arc discharge, making it flash at step S33. Image data of a photographed image is recorded in RAM (buffer memory) of the recording storage 55 at step S34.

The flash light by arc discharge is automatically ceased by a light-emitting ceasing signal output from a light-emitting cease switching element 45.

Thereafter, the image data recorded in RAM of the storage 55 is transferred to RAM (image memory) at step S35, and it is judged at step S36 whether the image data meets the condition represented by the following formula (6). When it is determined that the number of photographed frames “X” does not meet the formula (6) (NO at step S36), a value of “1” is added to the number of frames “X” at step S37, and then the following process is performed again at steps S26 to S35.
X≧n (6)

Since every frame is photographed with the light emitting position for illuminating the object and illuminating angle changed, a desired light volume of illumination or an properly shaded image may be obtained. When a person is photographed, plural images of the person with three-dimension, facial relief, shade and facial impression slightly changed may be obtained. Further, a picture of a person with desired facial impression may be easily obtained by selecting one from among the plural photographed frames.

When it is determined that the number of photographed frames “X” meets the formula (6) (YES at step S36), the image data is subjected to a compression process to be encoded in the compression processing unit 57. The encoded data is recorded in storage 55 or an installed recording medium 12 at step S38. A series of strobe bracket photograph operations have been completed.

Thereafter, the return processes are performed at step S39 to update various sorts of information, displaying same on the first and second display unit 17, 22. On the first display unit 17, a through image is displayed together with the various sorts of information at step S13.

While a certain flash light tube is emitting light, the main capacitor 43 of the other flash light tube is charged, whereby a photographing time in the continuous shooting is reduced, allowing an effective photographing operation.

When the sequence of photographing is set to a sequence other than the ascending sequence and descending sequence, or when set to “0+−”, for example, the sequence of “0+−” is confirmed at step S40 id FIG. 16, and the number of frames to be photographed “X” is set to “1” at step S41. Values of “K” and “F(X)” are calculated by using the following equations (7) and (8) at step S42, and further photographing process is performed in accordance with the results of calculation at step S43.
K=(X−1) (7)
F(X)=F0+K× (8)

Image data obtained by performing the photographing process is transferred to RAM (image memory) at step S44, and it is judged at step 45 whether the number of photographed frames “X” meets the following formula (9).
X>(n+1)/2 (9)

When it is determined that the number of photographed frames does not meet the formula (9) (NO at step S45), a value of “1” is added to the number of frames to be photographed (X) at step S46. Again, values of “K” and “F(X)” are calculated by using the above equations (7) and (8) at step S42, and the following process is performed at steps S43 and S44.

Meanwhile, when it is determined that the number of photographed frames meets the formula (9) (YES at step S45), the values of “K” and “F (X) “are calculated based on the following equations (10), (11) at step S47, and the photographing process is performed in accordance with these results of calculation at step S48.
K=−[X−(n+1)/2] (10)
F(X)=F0+K× (11)

Image data obtained by performing the photographing process is transferred to RAM (image memory) at step S49, and it is judged at step 50 whether the number of photographed frames “X” meets the following formula (12).
X≧n (12)

When it is determined that the number of photographed frames does not meet the formula (12) (NO at step S45), a value of “1” is added to the number of frames to be photographed “X” at step S51. Again, values of “K” and “F(X)” are calculated by using the above equations (10) and (11) at step S47, and the following process is performed at steps S48 and S49.

When it is determined that the number of photographed frames meets the formula (12) (YES at step S50), the following processes at steps S38 and S39 in FIG. 12 are performed.

In the digital camera 1 or image pick-up equipment of the present invention, since the light-emitting member driving unit 39 controls the light-emitting position of the light-emitting unit 38 based on the electric signal output from the light-emitting control unit 53, the continuous shooting for photographing plural pictures can be performed only by single release operation without successively correcting the light-emitting position of the flash light unit 26, whereby operability of the equipment is improved and the time needed for photographing operation is reduced, decreasing user's burden inflicted by photographing operation.

Since each flash light tube 40 is provided with the trigger coil 42 and main capacitor 43, even if electric power is consumed in the main capacitor 43 for a certain flash light tube which emits light, power consumption can be prevented in other main capacitors 43 of the other flash light tubes, whereby illumination by flash light tubes is controlled in a stable manner.

In the embodiment of the invention, in which the automatic illumination adjusting function is made active, the switching element makes the light-emitting unit cease emitting light at the time when the light emitting amount detected and compared by a comparator reaches an appropriate exposure value after lapse of a light emitting time set based on a light measurement amount of a provisional illumination light in a short time reflected on the object, or during illumination.

Based on the previously set photographing condition, exposure condition or light measurement value in the provisional illumination, the light emitting amount is automatically set so as to meet the appropriate exposure condition, and bases on the previously set photographing condition, the bracket conditions such as light emitting position and light emitting angle are sequentially corrected for each frame in the previously set correction sequence and interval, whereby the certain number of frames are photographed in success by single release operation.

### First Modification

In the embodiment of the invention, the light emitting members 40 of the light-emitting unit 28 are selectively switched to emit light to change the light-emitting position and angle against the object during the strobe bracketing photography. The embodiment of the invention may be modified such that every other light emitting members 40 of the light-emitting unit 38 is selectively switched to emit light, as shown in FIG. 17, whereby the light emitting angle may be corrected for effectively obtaining images with desired shade.

As shown in FIG. 18, the embodiment of the invention may be modified such that the certain number of light emitting members in the light-emitting unit 38 are selectively switched to emit light during strobe bracketing photography, whereby the strobe bracketing photography may be performed with much light volume, and images may be obtained under proper illumination in the dark place with little illumination.

Further, the embodiment may be modified such that the number, position and range of the light emitting members 40 of the light-emitting unit 38 are successively changed or switched during the strobe bracketing photography. For example, as shown in FIG. 19, the light-emitting member (first light-emitting member) disposed at the center of the light-emitting unit 38 is made to emit light in the photographing operation for the first frame, and two light-emitting members disposed adjacent to the first light-emitting member are made to emit light for the second frame. Further, three light-emitting members disposed adjacent to these two light-emitting members are made to emit light in the photographing operation for the third frame, and four light-emitting members disposed adjacent to these three light-emitting members are made to emit light for the fourth frame. The flash light emitting device 26 of the arrangement described above can correct the light-emitting angle and light-emitting amount of the light-emitting unit 38, whereby an image with desired shade is effectively obtained under appropriate illumination.

### Second Modification

In the embodiment of the camera equipment, the light-emitting members 40 of the light-emitting unit 38 are switched to emit light in the horizontal direction for the strobe bracketing photography, in other words the strobe bracketing photography is performed under light emitted from side of the object. The invention is not limited this arrangement, but the strobe bracketing photography may be performed under light emitted in the vertical direction by rotating the camera position by 90 degrees as shown in FIG. 20, in other words, the strobe bracketing photography may be performed under light of an ascending and descending vertical angle. The user can use the camera equipment conveniently by appropriately changing the light-emitting angle.

The flash light emitting device 26 may be comprised of plural light-emitting members 40 which are disposed in a line along the circumference of the image pick-up lens 31 on the front surface of the housing 2, as shown in FIG. 20. With this arrangement, the illumination is not limited to that from the horizontal direction or vertical direction but the strobe bracketing photography may be performed under light of various light-emitted angles.

Further, modification may be made such that an exposure angle may be switched to a desired angle by selecting an arbitrary light emitting member among those arranged so as to face different directions respectively to show different light-emitting angles. With this arrangement, even though the light-emitting members are disposed at positions not facing the object, as shown in FIG. 10, light may be emitted to the object effectively.

The light-emitting member 40 in the light-emitting unit 38 may be adapted so as to be rotated by a driving device 391 such as a motor, whereby the installation angle of the member 40 is turned to adjust the inclination angle of the member 40. With this arrangement, the light-emitting angle may be corrected precisely.

### Third Modification

In the embodiment of the camera equipment of the invention, a flash light discharging tube such as Xenon lamp is used as the light-emitting member 40 of the flash light emitting device 26. A white LED may also be used as the light-emitting member. A circuit configuration of the light-emitting member driving unit for driving the light-emitting member 40 such as LED is different from that for driving the light-emitting member 40 such as Xenon lamp. The circuit configuration of the light-emitting member driving unit for driving LEDs will be described in detail with reference to FIG. 22 to FIG. 24. The same configuration as that having been described in the above embodiments will not be described, again.

In case that white LEDs are used for the light-emitting members 40 in the light-emitting unit 38, a light-emitting member driving unit 71 is provided with a regulator 72 including DC/DC converter and charge pump, restriction resisters 73, and a light-emitting control unit 53 in place of the booster charging circuit 41, trigger coil 42 and main capacitor 43.

In the light-emitting member driving unit 71 for driving LEDs, a voltage is raised to several or several tens volts by the regulator 72, and the raised voltage is directly applied to each light-emitting member 40 to make same emit light without charging operation for each light-emitting member.

In particular, since a high voltage is not required for LED to emit light, LED needs no capacitor. But the light-emitting member driving unit 71 has two capacitors 76, 77 provided at both sides of the regulator for a charging purpose.

With this arrangement including capacitors 76, 77, illumination by emitting light is made brighter, and since little charge is required (or no charge is required in case no capacitor is provided), this arrangement is proper to emit flash light continuously, when photographing operations are performed for many times in success.

As shown in FIG. 23, the light-emitting member driving unit 71 for driving LEDs may be provided with a driving circuit 75 having a regulator and driving circuit in combination. The light-emitting member driving unit 71 of this arrangement emits light in a pulse wave manner having a certain pulse width, as shown in FIG. 24.

The light-emitting member driving unit 71 shown in FIG. 23 is provided with a capacitor 76, and therefore the electric power charged in the capacitor 76 makes the white LED emit light. LED can emit brighter light than that with no capacitor connected.

In the light-emitting member driving unit 71 having capacitors 76, the capacitors are provided independently from each other, and the number of the capacitors are the same as white LEDs. With this arrangement, even if the electric power charged in a capacitor corresponding to LED emitting light is consumed, the electric power charged in the capacitor corresponding to LED other than the emitting LED is prevented from being consumed, whereby light emitting operation can be controlled more stably.

As described above, when the white LEDs are used as the light-emitting members 40 in the flash-light emitting device 26, there is no need to raise the voltage to several thousands volts, but a voltage of several or several tens volts is sufficient to make LED emit light. Therefore, no trigger coil 42 is needed. Further, the light emitting member 40 can be made to emit light by a voltage raised by the regulator 72, whereby the circuit configuration is made simple and finally the device can be made compact in dimension.

LED used as the light-emitting member is not limited to white LED, but red (R), green (G), and blue (B) LED can be used, which emit single-color lights respectively to be subjected to additive color mixture to generate a white color light in a pseudo manner.

FIG. 26 is a spectrum chart of lights emitted by LEDs which have a blue, green, yellow green, yellow, orange and red color characteristic, respectively. FIG. 27 is a spectrum chart a white light generated in a pseudo manner by a combination of a blue LED and yellow fluorescent material. FIG. 28 is a spectrum chart of a white light generated in a pseudo manner by a combination of ultraviolet LED, red, green and blue LED.

In FIG. 26 to FIG. 28, the vertical axis represents a relative light-emitting intensity and the horizontal axis represents a wavelength (nm).

When a white light is reproduced in a pseudo manner by additive color mixture of original lights of LEDs having various characteristics, dispersion characteristics can be equalized and the reproduced white light can be corrected so as to come near the dispersion characteristics of the sunlight by making LEDs having wavelengths in a middle range emit light simultaneously.

Various color lights can be reproduced by mixing various single color lights, and therefore color of the illumination can be changed for each photographing operation, and continuous shooting may be performed with color of illumination changed, whereby an image of desired effect including hue depending on the object to be photographed and circumference may be obtained or selected.

An example of arrangement of light-emitting members 40 or LEDs of the light-emitting unit 38 is shown in FIG. 29.

In the arrangement, a purple (P), yellow green (YG), white (W), yellow (Y), orange (O) LED in addition to R, G, B LED, that is, eight color LEDs are disposed in the horizontal direction. First five color LEDs are used to correct a color of light. In the light emitting unit 38 having the structure described above, LEDs are switched successively, as shown in FIG. 30, to be made to emit light, changing a light emitting position and angle, and also changing a color of flashing light for every image in the continuous shooting, whereby the strobe bracketing photography is performed with the color of emitted light changed.

In FIG. 31, LED emitting white light which is used as the fundamental light is turned on at all times, and other LEDs emitting other color are successively switched, whereby the strobe bracketing photography is performed with bias in the spectroscopic character of the white LED corrected.

In the light emitting unit using LEDs as the light emitting members 40, an arrangement in which LED assemblies are disposed in horizontal direction may be used, as shown in FIG. 32, each LED assembly including LEDs of RGB lights and LED of white light disposed in matrix.

The above arrangement of the light emitting unit 38 allows to reduce the dimension of the light-emitting unit 38, and further allows to dispose more LEDs, even if it is hard to disposed LEDs in the horizontal direction because of restriction in disposal of the light-emitting unit due to the dimension or shape of the camera equipment.

Further, as shown in FIG. 33 to FIG. 35, an arrangement may be used, in which single color LEDs and white LEDs are combined such that the total area of the single color LEDs becomes smaller than the total area of the white LEDs.

In the above arrangement of the light-emitting unit 38, since the single color LEDs are used to correct the white light emitted from the white LEDs, it is possible to decrease the total light emitting-area of the single light LEDs to the minimum area which is necessary to realize the similar effect to that obtained by correction described above, that is, it is possible to make the total area of the single light LEDs smaller than the area of white LEDs, whereby it is possible to decrease the dimension of the light-emitting unit 38.

### Fourth Embodiment

Further, in the camera equipment according to the embodiment of the invention, the continuous shooting is performed solely, but the continuous shooting may be performed in combination with AEB, which will be described in detail with reference to FIG. 36 to FIG. 39.

When the operation button 19 or the cross key at the left side is depressed in the normal photograph mode, the operation mode is switched to the bracket photograph mode. When the guide display button 20 is depressed in the bracket photograph mode, the bracket photograph mode is further switched to the bracket photographing setting mode, where a corrected interval, corrected sequence of photographing, or the corrected number of frames to be photographed are set. Then, when the guide display button 20 is depressed after the bracket condition has been set, the bracket photograph setting mode is switched to the bracket photograph mode, again.

In the bracket photograph mode, photographing condition is readout at step S101 in FIG. 36. various processes are performed under the photographing condition at step S102 to display various sorts of information on the first and second display unit 17, 22 and further to display a through image on the first display unit at step S103. Then, it is judged on the first and second display unit 17, 22 at step S104, whether the main capacitor 43 of the light-emitting member driving unit 39 in the flash light-emitting device 26 has been charged completely. When it is determined that the main capacitor 43 has not yet been charged completely (NO: at step S104), the main capacitor 43 is charged in the manner described above at step S105.

Meanwhile, when it is determined that the main capacitor 5 has been charged completely (YES at step S104), the user determines at step S106 whether he or she depresses the shutter button 5. When the user does not depress the shutter button 5 (NO at step S106), the user is given another opportunity to determine whether he or she depresses the shutter button 5 at step S106. When the user depressed the shutter button 5 (YES at step S106), the automatic light adjusting function makes the light-emitting unit 38 in the flash light-emitting device 26 emit light previously or provisionally at step S107, and receives light reflected from the object to measure light for light adjustment at step S108.

At step S109 in FIG. 37, the exposure condition set in the normal photograph setting mode, or a segment “Ev0”, variation [symbol] and the total number of sets of frames to be photographed “m” (odd number) are set to the light-emitting control unit 53. Further, a segment “F0”, variation [symbol] and the total number of sets of frames to be photographed “n” (odd number) for light-emitting angle or light-emitting position correction set in the bracket photograph setting mode are set to the light-emitting control unit 53 at step S110.

After various sorts of information have been set, the sequence of photographing for the exposure condition or light-emitting amount correction is confirmed at step S111. When the “ascending sequence” has been confirmed at step S112, the sequence of photographing “b” is set to “+1” at step S113. Meanwhile, it has been confirmed at step S114 that the descending sequence” is confirmed as the sequence of photographing, the sequence of photographing “b” is set to “−1” at step S115. Further, the sequence of photographing for the light-emitting angle or light-emitting position is confirmed at step S116. When the “ascending sequence” has been confirmed at step S117, the sequence of photographing “a” is set to “+1” at step S118. Meanwhile, it has been confirmed at step S119 that the descending sequence” is confirmed as the sequence of photographing, the sequence of photographing “a” is set to “−1” at step S120.

Thereafter, the number of sets to be photographed “Y” is set to “1” at step S121 in FIG. 38.

Values of “L” and “Ev(Y)” are calculated using the following equations (13), (14) at step S122.
L=b×[Y−(m+1)/2] (13)
Ev(Y)=Ev0+L× (14)

Further, the number of sets to be photographed “X” is set to “1” at step S123, and values of “K” and “F(X)” are calculated using the following equations (15), (16) at step S124.
K=a×[X−(n+1)/2] (15)
F(X)=F0+K× (16)

After the values of “Ev(Y)” and “F(X)” have been calculated, photographing operation is performed under combination of any one of the exposure condition and light-emitting amount correction and any one of the light-emitting angle or light-emitting angle correction at step S125. After performing the photographing operation, it is judged at step S126 whether the number of sets to be photographed “X” meets the condition represented by the following formula (17). When it is determined that the number of sets to be photographed “X” does not meet the condition represented by the following formula (17) (NO at step S126), a value of “1” is added to the number of sets to be photographed “X” at step S127, and the following processes at steps S124 to S125 are performed again.
X≧n (17)

Meanwhile, when it is determined that the number of sets to be photographed “X” meets the condition represented by the above formula (17) (YES at step S126), it is judged at step S128 whether the number of sets to be photographed “Y” meets the condition represented by the following formula (18). When it is determined that the number of sets to be photographed “Y” does not meet the condition represented by the following formula (18) (NO at step S128), a value of “1” is added to the number of sets to be photographed “Y” at step S129, and the following processes at steps S121 to S127 are performed again.
Y≧m (18)

When it is determined that the number of sets to be photographed “Y” meets the condition represented by the following formula (18) (YES at step S128), image data are compressed and encoded by the compression unit 57, and recorded in the storage unit 55 or external recording medium 12 at step S130, finishing a series of strobe bracket photograph operations. Then, a return process is performed at step S131 to display various sorts of updated information on the first and second display unit 17, 22, and further to display a through image on the first display unit 17 together with the various sorts of updated information at step S103.

As described above, “m” sets of frames are photographed under corrected exposure conditions or corrected light-emitting amounts and “n” sets of frames are photographed with corrected light-emitting positions or corrected light-emitting angles, that is, “m×n” sets of frames are continuously photographed in total with one single release operation by the user, whereby images are efficiently photographed with the desired light-emitting angle under the desired exposure condition.

Even though Xenon tubes are used in place of LEDs as the light-emitting members in the flash light-emitting device, plural light-emitting members are successively made to emit light respectively at exposure values, and while one light-emitting member is emitting light, the capacitor of the other light-emitting member is charged, whereby the photographing interval is shortened.

In the present modified embodiment of the camera equipment, as an example of the strobe bracketing photography described above, the continuous shooting is performed under exposure condition or light-emitting amount, but the photographing condition is not limited to the exposure condition or the light-emitting amount corrected, and the continuous shooting may be performed under combination of other photographing conditions such as WB.

In case of the continuous shooting, various images may be efficiently photographed while not only exposure condition, light-emitting amount, light-emitting position and light-emitting angle are corrected but other photographing condition such as WB are corrected.

The embodiments are arranged such that the number of frames to be photographed is set to an odd number such as 1, 3, 5, 7, and soon, but the invention is not limited to the above embodiments, and the number of frames to be photographed may be set to an arbitrary positive number. It is proposed that in such arrangement, for example, when the number of frames to be photographed is set to eight, the photographing process is performed as if the number of frames has been set to nine, and at the time when eight frames have been photographed, the process is accounted to be completed and the last frame is not photographed.

### Fifth Embodiment

The camera equipment 1 according to the embodiments of the invention, the flash light-emitting device 26 is built in the equipment, but the invention is not limited to the above embodiments. A digital camera equipment 101 may be constructed so as to receive a detachable flash light-emitting device 102, as shown in FIG. 40.

The image pick-up apparatus of the present embodiments is the camera equipment 1 with the flash light-emitting device 26 built-in, but the invention is not limited to the above apparatus. The image pick-up equipment may be a compact type communication apparatus provided with a built-in flash light-emitting device, such as a cellular phone and PHS (Personal Handy phone System), as shown in FIG. 41 to FIG. 43.

A cellular phone 111 illustrated in FIG. 41 has an upper body 112 and lower body 113, both of which are connected so as to take an open position or a closed position with help of a hinge 115. The hinge 115 is provided with a shutter button 114 at its side surface.

The cellular phone 111 is provided with three image pick-up units 118, 119 and 120 respectively on the end surface of the hinge unit 115 opposite to the surface on which the shutter button 114 is provided, on the upper portion to the first display unit 116 on a front surface of the upper body 112, and in the vicinity of the second display unit 117 on the rear surface of the upper body 112. In the vicinity of these image pick-up units 118, 119, and 120, there are installed flash light-emitting devices 121, 122, and 123, each having plural light-emitting members so as to show effects similar to those in the embodiments of the invention.

The present invention is not limited to those embodiments as described above, and change or modification may be made to the embodiments within the scope of the invention when the invention is carried out. The functions executed in the embodiments may be combined in various ways to be carried out. The invention in various stages is included in the embodiments, and various inventions may be derived from appropriately combining plural elements which have been disclosed herein. For example, if the similar effects of the embodiment (modification) are obtained with some of elements omitted from the whole structure, such arrangement with some elements omitted may be derived as an invention.

What is claimed is:

1. Image pick-up equipment comprising:
an image pick-up unit for performing a photographing operation in response to a release operation by a user;
a photographing control unit for making the image pick-up unit execute a bracket photographing operation to perform photographing operations plural times in success in response to a single release operation by the user;
a light-emitting unit having plural light-emitting members disposed respectively at different positions;
a light-emitting control unit for generating an electric signal for controlling light-emitting operation of the light-emitting unit for each photographing operation in the bracket photographing operation of the image pick-up unit;
charge storage units provided respectively for the light-emitting members of the light-emitting unit; and
a light-emitting member driving unit for driving the plural light-emitting members of the light-emitting unit separately so as to emit light or cease emitting light, and for charging the charge storage unit of the light-emitting member while other light-emitting member is emitting light.

2. The image pick-up equipment according to claim 1, wherein the light-emitting member of the light-emitting unit comprises a flash light discharging tube.

3. The image pick-up equipment according to claim 1, wherein the light-emitting control unit controls the light-emitting unit so as to emit light under a light-emitting condition different for each photographing operation.

4. The image pick-up equipment according to claim 1, wherein the light-emitting control unit controls the light-emitting unit so as to emit light under an exposure condition different for each photographing operation.

5. The image pick-up equipment according to claim 3, wherein the light-emitting members of the light-emitting unit are disposed so as to have predetermined optical axis directions respectively, and the light-emitting condition includes the position of the light-emitting member.

6. The image pick-up equipment according to claim 5, wherein the light-emitting members of the light-emitting unit are disposed such that the optical axis directions of the light-emitting members lie in parallel with each other.

7. The image pick-up equipment according to claim 5, wherein the light-emitting members of the light-emitting unit are disposed so as to have different optical axis directions from each other, and the light-emitting condition includes a light emitting angle of the light-emitting member.

8. The image pick-up equipment according to claim 7, wherein the light-emitting unit is provided with an adjusting device for adjusting the optical axis direction of the light-emitting member.

9. The image pick-up equipment according to claim 1, wherein the light-emitting control unit controls the light-emitting unit so as to make at least two light-emitting members emit light simultaneously, and the light-emitting condition includes at least one of a light-emitting amount and light-emitting pattern of the light-emitting unit.

10. Image pick-up equipment comprising:
an image pick-up unit for performing a photographing operation in response to a release operation by a user;
a photographing control unit for making the image pick-up unit execute a bracket photographing operation to perform photographing operations plural times in success in response to a single release operation by the user;
a light-emitting unit having plural light-emitting members disposed respectively at different positions, the light-emitting member including a light-emitting diode;
a light-emitting control unit for generating an electric signal for controlling light-emitting operation of the light-emitting unit for each photographing operation in the bracket photographing operation of the image pick-up unit; and
a light-emitting member driving unit for driving the plural light-emitting diodes of the light-emitting unit separately so as to emit light or cease emitting light.

11. The image pick-up equipment according to claim 10, wherein the light-emitting control unit controls the light-emitting unit so as to emit light under a light-emitting condition different for each photographing operation.

12. The image pick-up equipment according to claim 10, wherein the light-emitting control unit controls the light-emitting unit so as to emit light under an exposure condition different for each photographing operation.

13. The image pick-up equipment according to claim 11, wherein the light-emitting members of the light-emitting unit are disposed so as to have predetermined optical axis directions respectively, and the light-emitting condition includes the position of the light-emitting member.

14. The image pick-up equipment according to claim 13, wherein the light-emitting control unit controls the light-emitting unit so as to make at least two light-emitting diodes emit light simultaneously, and the light-emitting condition includes at least one of a light-emitting amount and light-emitting pattern of the light-emitting unit.

15. The image pick-up equipment according to claim 13, wherein the light-emitting members of the light-emitting unit are disposed such that the optical axis directions of the light-emitting members lie in parallel with each other.

16. The image pick-up equipment according to claim 13, wherein the light-emitting members of the light-emitting unit are disposed so as to have different optical axis directions from each other, and the light-emitting condition includes a light emitting angle of the light-emitting member.

17. The image pick-up equipment according to claim 13, wherein the light-emitting member driving unit is provided with an electric charge storage unit.

18. The image pick-up equipment according to claim 13, wherein the light-emitting diode is a white light emitting diode which emits white flash light.

19. The image pick-up equipment according to claim 13, wherein each of the light-emitting diodes emit a single color light, and the single color lights emitted by the light-emitting diodes are subjected to additive color mixture to generate white color light.

20. The image pick-up equipment according to claim 18, wherein the light-emitting unit comprise a white light emitting diode and
a single color light emitting diode, and a light-emitting area of the single color light emitting diode is smaller than a light-emitting area of the white light emitting diode.

21. The image pick-up equipment according to claim 19, wherein the light-emitting unit comprise a white light emitting diode and
a single color light emitting diode, and a light-emitting area of the single color light emitting diode is smaller than a light-emitting area of the white light emitting diode.

22. A method of controlling image pick-up equipment which has a light-emitting unit including plural light-emitting members, each light-emitting member provided with a charge storage unit, the method comprising the steps of:
executing a bracket photographing operation to perform photographing operations plural times in success in response to a single release operation;
determining a light-emitting condition including at least one of a light-emitting position and light-emitting angle;
generating an electric signal for controlling a light-emitting operation for each photographing operation based on the determined light-emitting condition;
making the light-emitting unit emit light based on the generated electric signal; and
charging the charge storage unit of the light-emitting member while other light-emitting member is emitting light.

23. A method of controlling image pick-up equipment which is provided with a light-emitting unit including plural light-emitting diodes, the method comprising the steps of:
executing a bracket photographing operation to perform photographing operations plural times in success in response to a single release operation;
determining a light-emitting condition including at least one of a light-emitting position and light-emitting angle;
generating an electric signal for controlling a light-emitting operation for each photographing operation based on the determined light-emitting condition; and
making the light-emitting unit emit light based on the generated electric signal.

24. A storage medium storing a control program, the control program for controlling a light-emitting unit which has plural light-emitting members each provided with a charge storage unit, the control program comprising:
a code for executing a bracket photographing operation to perform photographing operations plural times in success in response to a single release operation by a user;
a code for determining a light-emitting condition including at least one of a light-emitting position and light-emitting angle;
a code for generating an electric signal for controlling a light-emitting operation for each photographing operation based on the determined light-emitting condition;
a code for making the light-emitting unit emit light based on the generated electric signal; and
a code for charging the charge storage unit of the light-emitting member while other light-emitting member is emitting light.

25. A storage medium storing a control program, the control program for controlling a light-emitting unit having plural light-emitting diodes, the control program comprising:
a code for executing a bracket photographing operation to perform photographing operations plural times in success in response to a single release operation by a user;
a code for determining a light-emitting condition including at least one of a light-emitting position and light-emitting angle;
a code for generating an electric signal for controlling a light-emitting operation for each photographing operation based on the determined light-emitting condition; and
a code for making the light-emitting unit emit light based on the generated electric signal.

26. Image pick-up equipment having a flash light-emitting device for a bracket photograph operation for performing photographing operations plural times in success in response to a single release operation by a user, the equipment comprising:
light-emitting control means for generating an electric signal for controlling light-emitting operation of the flash light-emitting device for each photographing operation in the bracket photographing operation;
light-emitting means having plural light-emitting members disposed at different positions or having different light-emitting angles, respectively;
electric charge storage means provided for each of the light-emitting members of the light-emitting means; and
light-emitting member driving means for making the light-emitting member of the light-emitting means emit light or cease emitting light separately from other based on the generated electric signal, and for charging the electric charge storage means of the light-emitting member while other light-emitting member is emitting light.

27. Image pick-up equipment having a flash-light emitting device for a bracket photographing operation for performing photographing operations plural times in success in response to a single release operation by a user, the equipment comprising:
a memory for storing photographed image data;
light-emitting control means for generating an electric signal for controlling light-emitting operation of the flash light-emitting device for each photographing operation in the bracket photographing operation;
light-emitting means having plural light-emitting members disposed at different positions or having different light-emitting angles, respectively;
light-emitting member driving means for making the plural light-emitting members of the light-emitting means emit light or cease emitting light separately from other based on the electric signal generated by the light-emitting control means; and
image pick-up means for photographing an object plural times in response to a single release operation under illumination of the light-emitting members disposed at different positions to obtain plural image data, and for storing the obtained image data in the memory.

28. Image pick-up equipment having a flash light-emitting device for a bracket photographing operation for performing photographing operations plural times in success in response to a single release operation by a user, the equipment comprising:
light-emitting control means for generating an electric signal for controlling light-emitting operation of the flash light-emitting device for each photographing operation in the bracket photographing operation;
light-emitting means having plural light-emitting diodes disposed at different positions or having different light-emitting angles respectively; and
light-emitting member driving means for making the light-emitting diode of the light-emitting means emit light or cease emitting light separately from other based on the electric signal generated by the light-emitting control means.

29. The image pick-up equipment according to claim 1, wherein the light-emitting control unit controls the light-emitting unit so as to emit light under a light-emitting condition different for every photographing operation.

30. The image pick-up equipment according to claim 10, wherein the light-emitting control unit controls the light-emitting unit so as to emit light under a light-emitting condition different for each photographing operation.
